(19) United States
(12) Patent Application Publication
(10) Pub. No.: US 2008/0189447 A1
(43) Pub. Date: Aug. 7, 2008

(54) Interactive System

(76) Inventors: David Hoch, Belmont, MA (US); Andrew Kennedy Lang, Wellesley, MA (US)

Correspondence Address: Merle Richman;Richman and Associates, P.O.Box 3333, La Jolla, CA, 92038-3333, US

(21) Appl. No.: 11/587,231

(22) PCT Filed: Apr. 22, 2005
(86) PCT No.: PCT/US05/13745

§ 371 Date: Sep. 16, 2007

Related U.S. Application Data
(60) Provisional application No. 60/565,133, filed on Apr. 23, 2004.

(51) Int. Cl. G06F 13/10

(52) U.S. Cl. 710/16

(57) ABSTRACT

A system and method include and control multiple controllable interactive components (10) that may be employed in various environments including sporting environments. The system may also include controllable (10) or non-controllable non-interactive components (30). These components (40) may include power supplies (42) that supply energy to the components (non-interactive and interactive) via a plurality of bus bars (20a, 20b) coupled together to form a bus bar system. Low speed data may be communicated on the bus bar system between components and a system controller (210). The system controller (210) may monitor and modify the operation of components (10) via the bus bar system (20a, 20b) are provided for interacting one or more individuals.

### BACKGROUND

1. Field of the Invention

The present invention generally relates to interactive systems, and more particularly, to an interactive system having multiple components that interact with users.

2. Description of Related Art

Interactive systems may enable one or more users to experience an environment that reacts to their inputs. The present invention provides architecture that includes multiple controllable interactive components that may be employed in various environments including sporting environments to an interactive system.

### SUMMARY OF THE INVENTION

The present invention provides architecture that includes multiple controllable interactive components that may be employed in various environments including sporting environments. The architecture may also include controllable or non-controllable non-interactive components. These components may include power supplies that supply energy to the components (non-interactive and interactive) via a plurality of bus bars coupled together to form a bus bar system. Low speed data may be communicated on the bus bar system between components and a system controller. The system controller may monitor and modify the operation of components via the bus bar system.

The present invention also includes an interactive system having several controllable interactive components, several bus bars, and at least one power supply. Each controllable interactive component may include means for detecting some physical characteristic of a user proximal to the controllable interactive component. The components also may include means for transmitting the detected physical characteristic in a data signal to an interactive component system controller. The interactive system may further include a plurality of bus bars, the bus bars forming a network where each of the plurality of controllable interactive components is electrically coupled to the bus bar network at least once. The system may also include a power supply coupled to the bus bar network to provide power to the plurality of controllable interactive components.

In an embodiment, each controllable interactive component may further include means for generating a human detectable effect as a function of the detected physical characteristic. Each controllable interactive component may further include means for receiving a generate effect data signal from the interactive component system controller where the generate effect data signal is based on the detected physical characteristic and means for generating a human detectable effect based on the generate effect data signal. In one embodiment the means for generating a human detectable effect based on the generate effect data signal may include a photon generation element.

The system may also include a non-interactive component electrically coupled to the bus bar network where the non-interactive component including means for generating a human detectable effect. In another embodiment each controllable interactive component may further include means for detecting some physical characteristic of a moving, non-human object proximal to the controllable interactive component. The component may further include means for generating a human detectable effect indicating a characteristic of the moving, non-human object proximal to the controllable interactive component.

In an embodiment, the means for transmitting the detected physical characteristic is electrically coupled to the bus bar network and the data signal is communicated to the interactive component system controller via the bus bar network. The means for receiving a generate effect data signal may also be electrically coupled to the bus bar network and the generate effect data signal is communicated from the interactive component system controller via the bus bar network.

In another embodiment, the means for transmitting the detected physical characteristic includes an optical transmitter. In addition, the means for receiving a generate effect data signal may include an optical receiver. Further, the plurality of controllable interactive components may communicate data signals between the interactive component system controller and each controllable interactive component via the optical transmitter and receiver serially.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a diagram of a component of an exemplary interactive system in accordance with the present invention.

FIGS. 2A to 2C are diagrams of exemplary bus bars that may be employed with component of FIG. 1 in an exemplary embodiment of the present invention.

FIG. 3 depicts an embodiment of the component of FIG. 1 with the exemplary bus bars of FIG. 2A to 2C in accordance with an embodiment of the present invention.

FIG. 4 depicts a plurality of interconnected components and bus bars in accordance with an embodiment of the present invention.

FIG. 5 depicts a diagram of another component, a border tile with bus bars in accordance with an embodiment of the present invention.

FIG. 6 depicts a diagram of another component, a power supply border tile with bus bars in accordance with an embodiment of the present invention.

FIG. 7 depicts a plurality of tiles, border tiles, and power supply border tiles in accordance with an embodiment of the present invention.

FIG. 8 depicts a plurality of tiles, border tiles, and power supply border tiles in accordance with an embodiment of the present invention where the border tiles include illuminated graphics.

FIG. 9 depicts a diagram of another exemplary tile employing a first plurality of optical transceivers in accordance with the present invention.

FIG. 10 depicts a diagram of another exemplary tile employing a second plurality of optical transceivers in accordance with the present invention.

FIG. 11 depicts a diagram of a plurality of interconnected tiles, the tiles including a plurality of optical transceivers in accordance with the present invention.

FIG. 12 depicts a diagram of another exemplary tile employing a plurality of strain gauges in accordance with the present invention.

FIG. 13A is a diagram of a unidirectional strain gauge that may be employed in the exemplary tile shown in FIG. 12.

FIG. 13B is a diagram of a bi-directional strain gauge that may be employed in the exemplary tile shown in FIG. 12.

FIG. 14 is a diagram of an exemplary component sub-element with a single non-central lighting element.

FIG. 15 is a diagram of an exemplary component sub-element with a single non-central lighting element further including a grating pattern to even the light energy distribution on the surface of the sub-element in accordance in with the present invention.

FIG. 16A is a diagram of an exemplary component sub-element with two non-central lighting elements.

FIG. 16B is a diagram of an exemplary component sub-element with two non-central lighting elements further including a grating pattern to even the light energy distribution on the surface of the sub-element in accordance in with the present invention.

FIG. 17A is a diagram of an exemplary component sub-element with four non-central lighting elements.

FIG. 17B is a diagram of an exemplary component sub-element with four non-central lighting elements further including a grating pattern to even the light energy distribution on the surface of the sub-element in accordance in with the present invention.

FIG. 18 depicts a diagram of an exemplary interactive component that may communicate with a user's wireless device in accordance with the present invention.

FIG. 19 depicts a diagram of an interactive component that may wirelessly communicate with a wireless controller in accordance with the present invention.

FIG. 20 depicts a diagram of an exemplary architecture where a user or system operator may employ the wireless controller of FIG. 19 to control one or more interactive components in accordance with the present invention.

FIG. 21 depicts a diagram of an exemplary implementation of the present invention in a sports environment, in particular a tennis court.

FIG. 22 depicts a diagram of another exemplary implementation of the present invention in a sports environment, in particular a basketball court.

FIG. 23 depicts a diagram of another exemplary implementation of the present invention in a sports environment, in particular a hockey rink.

FIG. 24 depicts a side view of the exemplary implementation of the present invention as shown in FIG. 23.

FIG. 25 depicts a diagram of exemplary interactive component having a controllable surface translucence in accordance with the present invention.

FIG. 26 depicts a cutaway bottom view of the interactive component of FIG. 25 having a controllable surface translucence in accordance with the present invention.

FIG. 27A depicts a cutaway side view of the interactive component of FIG. 25 having a controllable surface translucence in accordance with the present invention.

FIG. 27B depicts a cutaway side view of the interactive component of FIG. 25 having a controllable surface translucence where the surface translucence is set to clear in accordance with the present invention.

FIG. 27C depicts a cutaway side view of the interactive component of FIG. 25 having a controllable surface translucence where the surface translucence is set to opaque in accordance with the present invention.

FIG. 27D depicts a cutaway side view of the interactive component of FIG. 25 having a controllable surface translucence where the surface translucence is set to slightly opaque in accordance with the present invention.

FIG. 28 depicts a diagram of an exemplary controllable power supplied equipped component with bus bars in accordance with an embodiment of the present invention.

FIG. 29 depicts a flow diagram of an exemplary process that may executed by the exemplary controllable power supplied equipped component shown in FIG. 28.

FIG. 30 depicts a block diagram of an exemplary system controller in accordance with an embodiment of the present invention.

FIG. 31 depicts a flow diagram of an exemplary process that may executed by the exemplary controller shown in FIG. 30 to control one or more power supplied equipped components.

FIG. 32 depicts a diagram of an exemplary architecture including a wirelessly controllable non-interactive component and wireless device in accordance with an embodiment of the present invention.

FIG. 33 depicts a diagram of a controllable non-interactive component in accordance with an embodiment of the present invention.

FIG. 34A depicts a diagram of a component covered with a translucent film in accordance with an embodiment of the present invention.

FIG. 34B depicts a side view of a component covered with a translucent film in accordance with an embodiment of the present invention.

FIG. 34C depicts a side view of a component covered with multiple layers of removable translucent film in accordance with an embodiment of the present invention.

FIG. 34D depicts a diagram of a plurality of components covered a translucent film in accordance with an embodiment of the present invention.

Throughout this description, embodiments and variations are described for the purpose of illustrating uses and implementations of the invention. The illustrative description should be understood as presenting examples of the invention, rather than as limiting the scope of the invention.

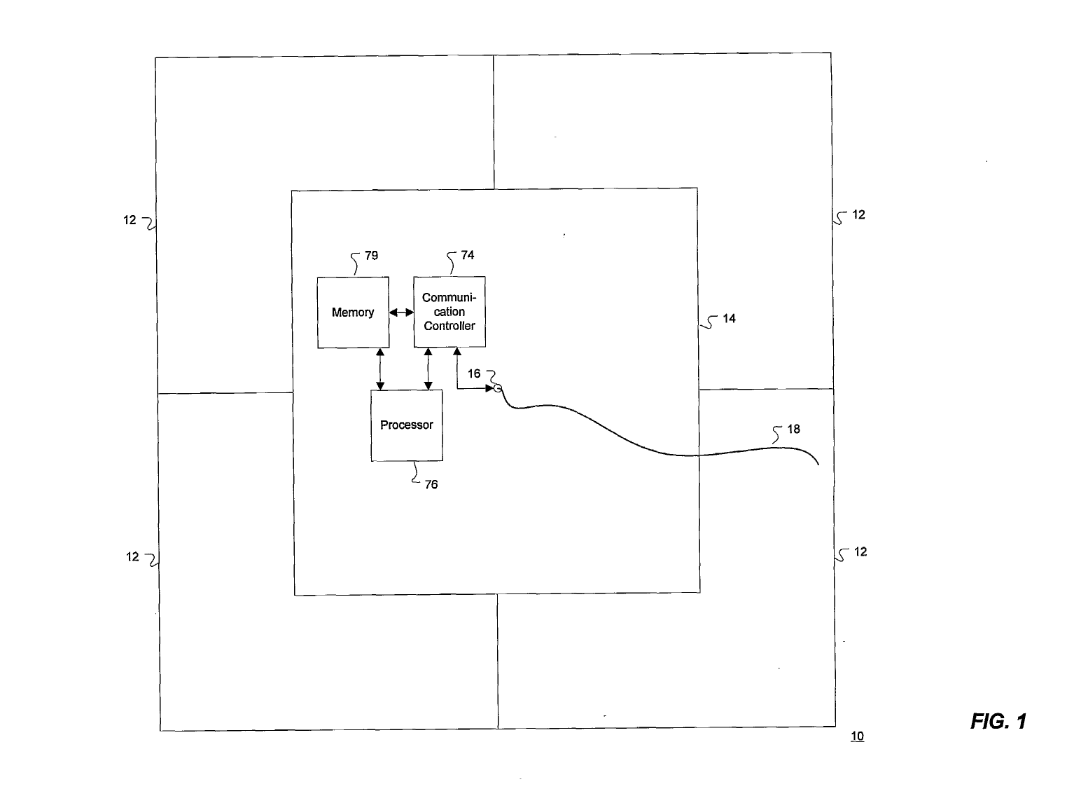

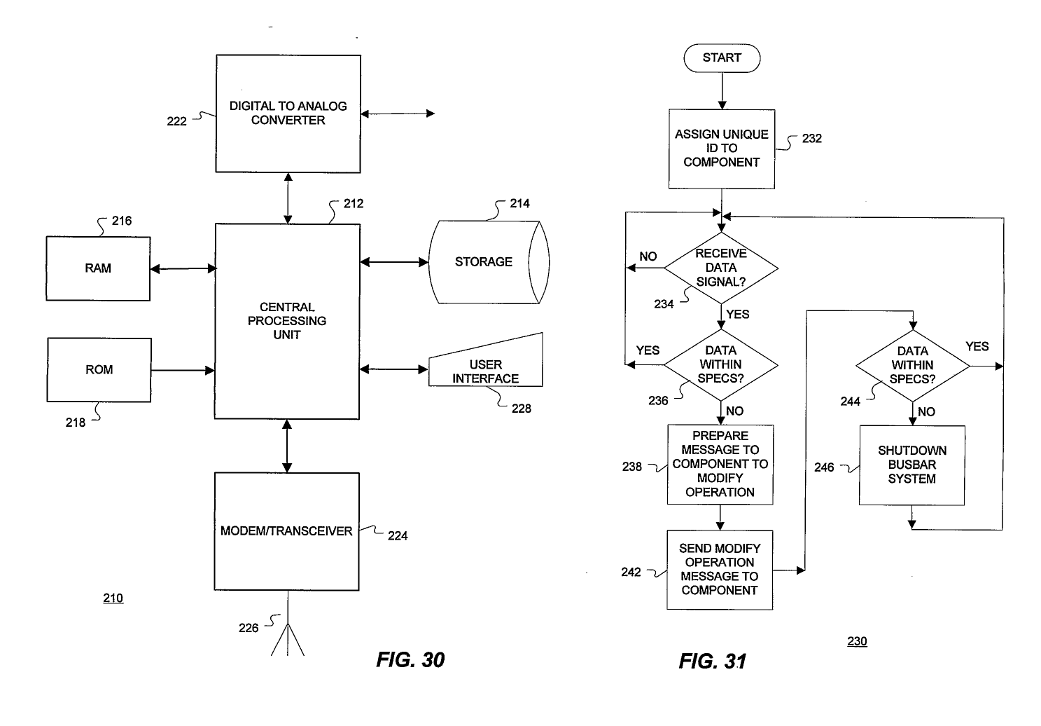

FIG. 1 is a diagram of an exemplary component 10 of an interactive system in accordance with the present invention. The exemplary component 10 is an interactive component, in one embodiment the component includes a plurality of lighting element segments, sub-elements, or lens 12, a printed circuit board (“PCB”) 14, and a communication cable 18. The PCB 14 may include a processor 76, a communication controller 74, and a memory 79. The processor 76 may be any programmable processor. The communication controller 74 may be another processor or Application Specific Integrated Circuit (“ASIC”) that enables two way communications according to one or more protocols. In an exemplary embodiment, the communication controller 74 may use at least an Ethernet based protocol for communication. The memory 79 may be any non-volatile or volatile memory such as Random Access Memory (“RAM”), (“ROM”), hard disk drive, optical drive, or other medium capable of storing and retrieving data. The memory 79 may store program instructions for the processor 76 or controller 74. The processor 76 may control the operation of the segments 12 and may send and receive control data for their operation via the controller 74 to one or more system controllers (FIG. 30).

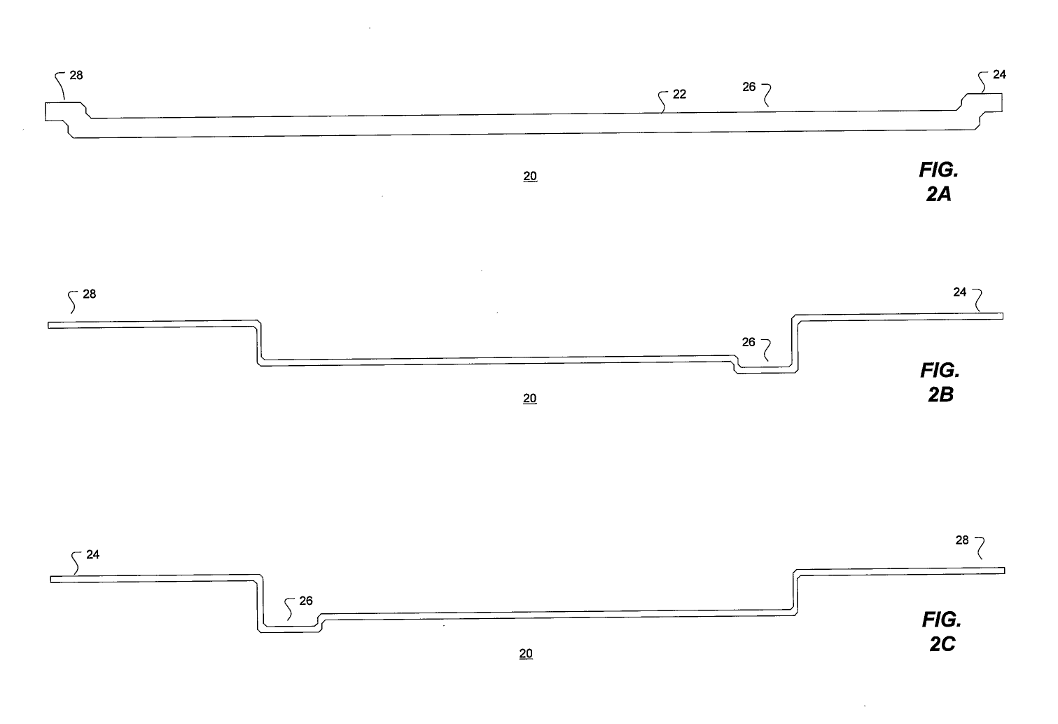

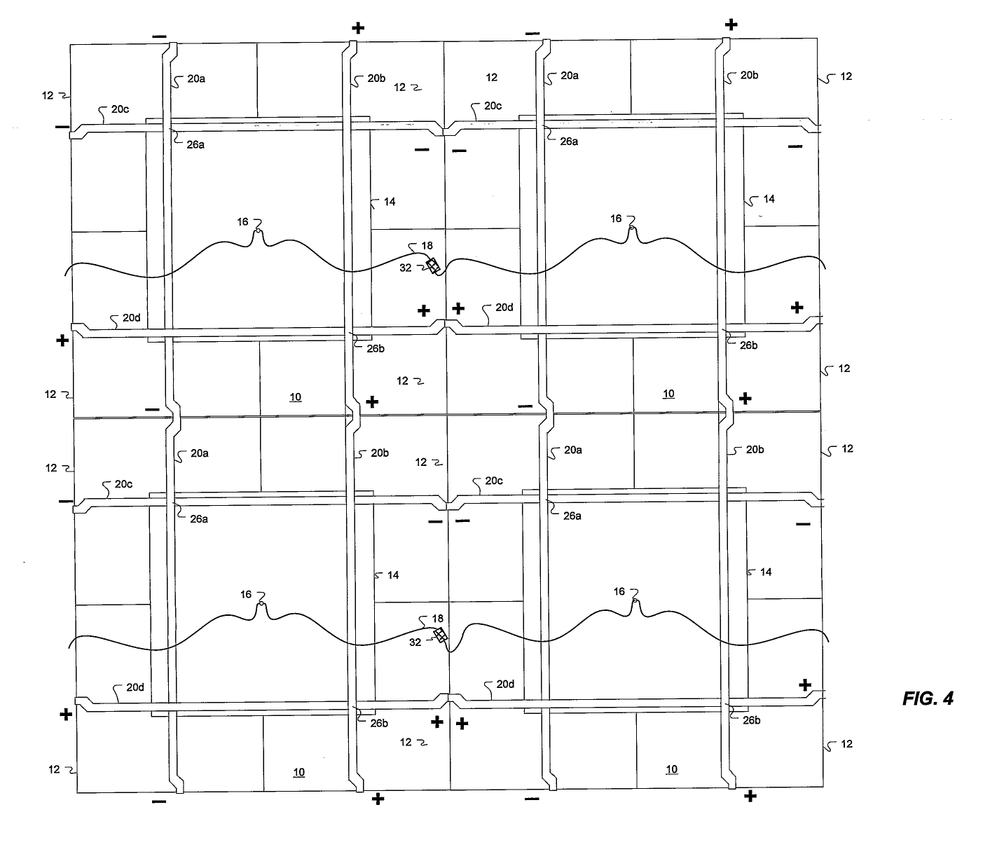

Communication cable 18 is coupled to the communication controller 74 via the connector 16. In an exemplary embodiment the connector 16 is a swivel connector that enables the cable 18 to be rotated in different directions for connection to an adjacent component as shown in FIG. 4. In an exemplary embodiment power may be delivered to the component 10 via one or more bus bars. FIGS. 2A to 2C are diagrams of an exemplary bus bar 20 that may be employed with component 10 of FIG. 1. FIG. 2A is a top view, FIG. 2B is a right side view, and FIG. 2C is a left side view of an exemplary bus bar 20.

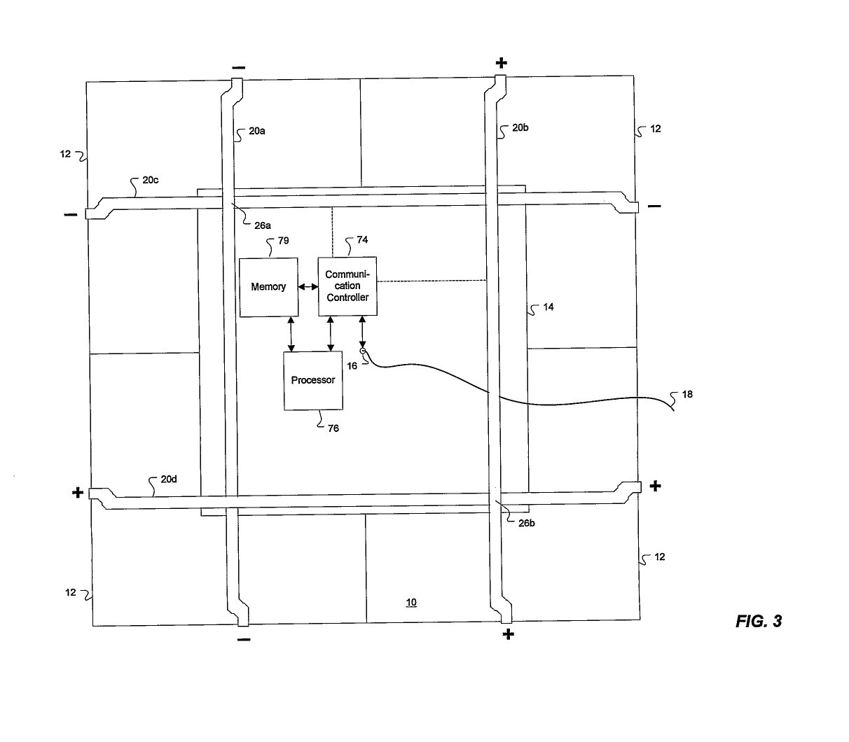

The exemplary bus bar 20 includes a long central section 22, a first distal end 24, a second distal end 28, and a contact point 26. FIG. 3 depicts an embodiment of the component 10 FIG. 1 with four exemplary bus bars 20a, 20b, 20c, and 20d (20 as shown in FIGS. 2A TO 2C) in accordance with an embodiment of the present invention. Bus bars 20a and 20b are placed in adjacent vertical configuration and bus bars 20c and 20d are placed in adjacent horizontal configuration according to one exemplary embodiment to form a bus bar system. In this exemplary embodiment, the bus bars 20a, 20b, 20c, and 20d are used to form a bus bar system where the system is employed to conduct electrical power to the PCB 14. Bus bars 20a and 20c are physically coupled at point 26a (due to the bus bar geometry) and bus bars 20b and 20d are physically coupled (form an electrical contact point) at point 26b. Due to the bus bar geometry, bus bars 20b and 20c do not have any contact points and bus bars 20a and 20d do not have any contact points. In this exemplary embodiment, one bus bar pair (20a, 20c) may have a first electrical characteristic (negative polarity) and bus bar pair (20b, 20d) may have a second electrical characteristic (positive polarity) in the bus bar system.

In an exemplary embodiment, the bus bar system may also conduct data signals to the PCB 14 where the data signals are modulated onto the electrical power signal (using any known data modulation technique). The PCB 14 via the processor 76 and communication controller 74 may modulate and demodulate signals on the bus bar system (bus bars 20a, 20b, 20c, and 20d). The same contact points 26a and 26b may contact one or more pads on the PCB 14 to provide operating power to the PCB 14 (and its associated components). FIG. 4 depicts a plurality of interconnected components with bus bars (as shown in FIG. 3). As shown in this figure like bus bars 20a, 20b, 20c, and 20d are interconnected to form a larger bus bar system. A connector (not shown) may be used between each bus bar connection (20a to 20a) to ensure permanent electrical conductivity.

Further, in an exemplary embodiment cables 18 may be electrically connected via a coupler 32 between each cable 18 pair to form an interconnection between components. The interconnection forms a data communication link between communication controllers 74 (shown in FIG. 4) of each component in an exemplary embodiment. The coupler 32 may be an electrical or optical coupler and cables 18 may be electrical or optical conductors in an exemplary embodiment. Further, cables 18 are coupled so each component in the interactive system is serially linked to every other component and a system controller 210 (shown in FIG. 30). Accordingly, the system controller 210 may be able to communicate data and control signals between each component of the interactive system via the serial linked cables 18 and bus bar system (in one exemplary embodiment). In another exemplary embodiment, the system controller 210 may limit data and control communication via the bus bar system to low speed signals including configuration and status signals.

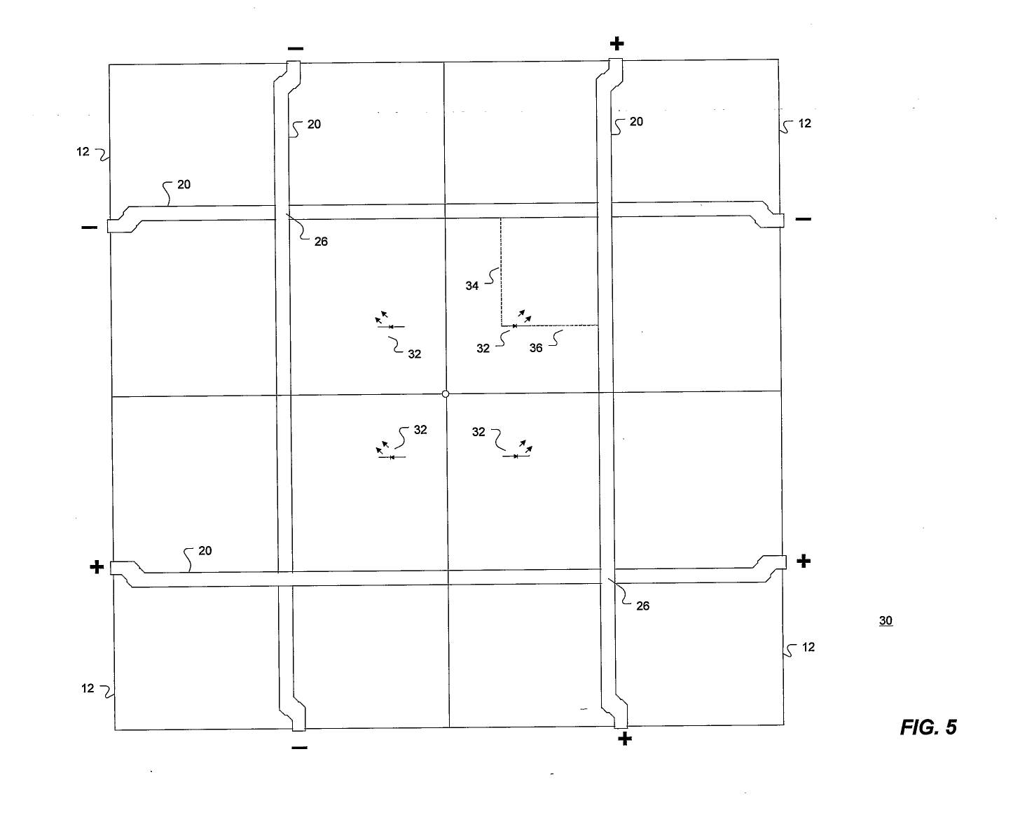

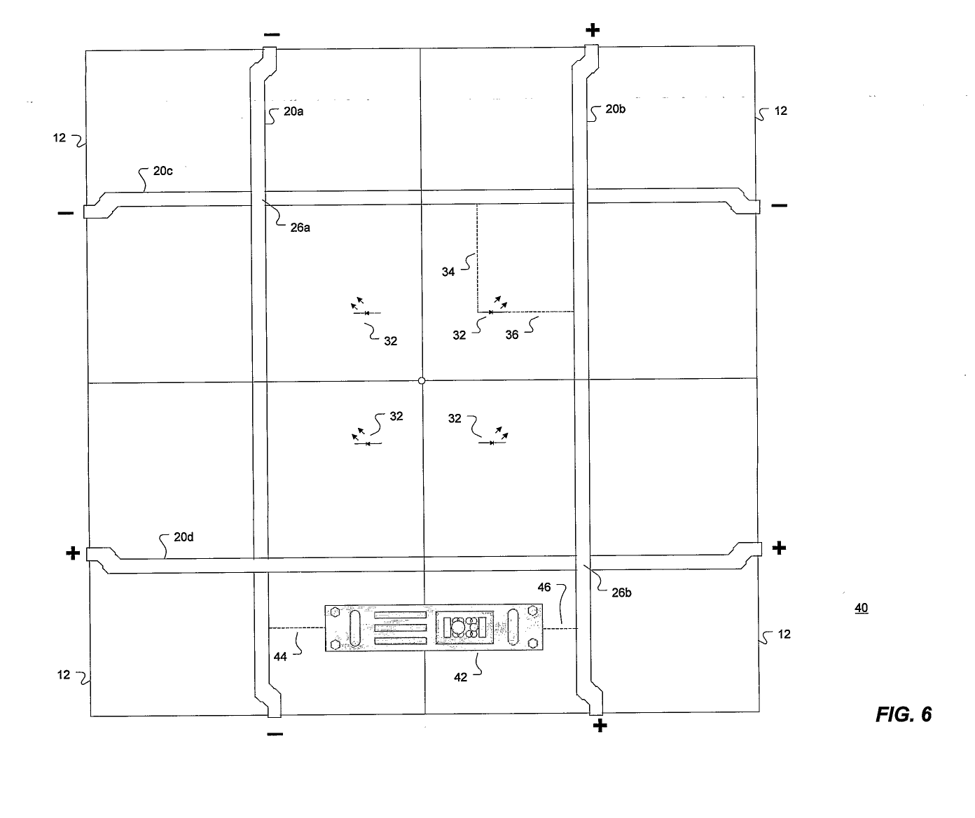

FIG. 5 depicts a diagram of another component 30 of an exemplary interactive system. The exemplary component 30 may be a non-interactive component (border component in one exemplary embodiment) with bus bars. In this exemplary embodiment the component 30 includes a plurality of lighting elements 32 coupled to the bus bar system. In one embodiment the lighting elements 32 are Light Emitting Diodes (“LED”). The lighting elements 32 may be directly connected to bus bar system (via connectors 34 and 36) to permanently power each lighting element. FIG. 6 depicts a diagram of another exemplary component 40, a power supply equipped non-interactive component (a power supplied border component with bus bars in one exemplary embodiment). Component 40, similar to component 30 further includes a current coupling power supply 42. The power supply 42 is electrically coupled to the bus bar system via a pair of electrical connectors 44, 46. The power supply 42 regulates the current level on the bus bar system and may interact with other power supplies (in other components 40) to maintain a desired current level in the bus bar system for a plurality of system components (10, 30, 40).

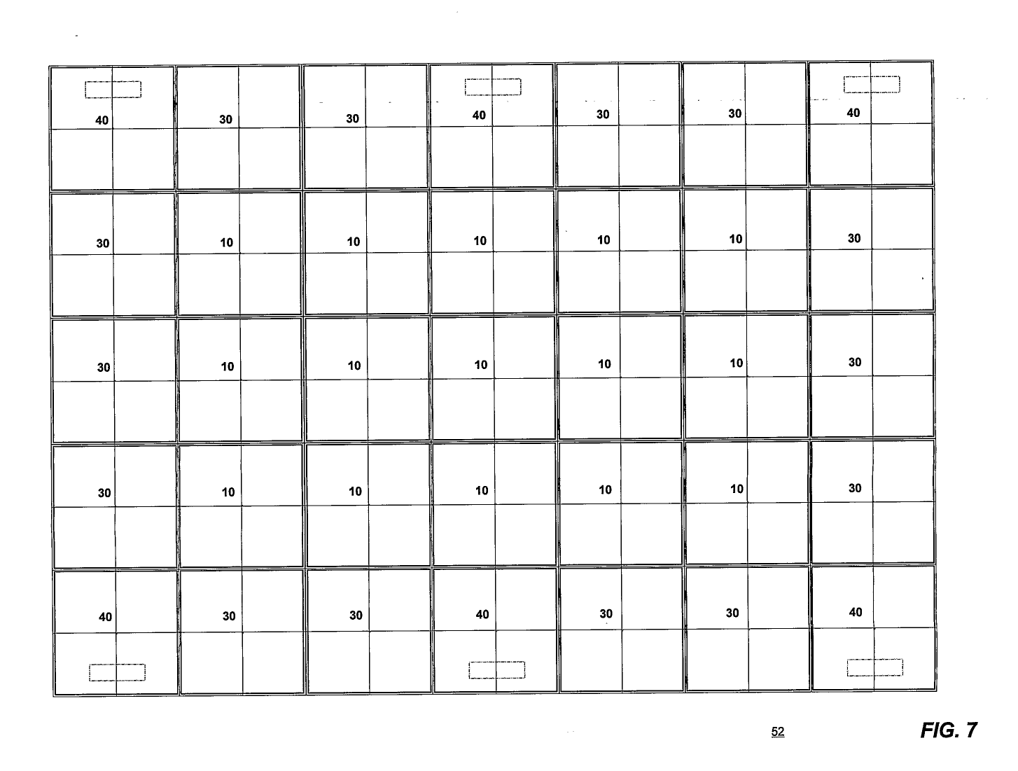

FIG. 7 depicts an exemplary architecture 52 having a plurality of components 10, 30, and 40 (interactive, border, and power supply equipped components in accordance with an embodiment of the present invention). The exemplary architecture includes fifteen (15) interactive components 10 surrounded by twenty (20) non-interactive components 30 and 40. In this exemplary embodiment a subset of the non-interactive components are power supplied equipped components 40, in particular six (6) components. Each power supply component 40 provides electrical energy to the bus bar system that couples all the components of architecture 52. The power supply components number ratio to total components may vary depending on the overall power requirements of the non-interactive and interactive components 40, 30, and 10. As shown in FIGS. 5 and 6, components 30 and 40 may produce a fixed physical detectable effect, in an exemplary embodiment they may produce a steady illumination via one or more LEDs of each component coupled to the bus bar system. In architecture 52 the components 30 and 40, which border the interactive components 10 may provide a launching and departing area for users seeking to interact with the components 10.

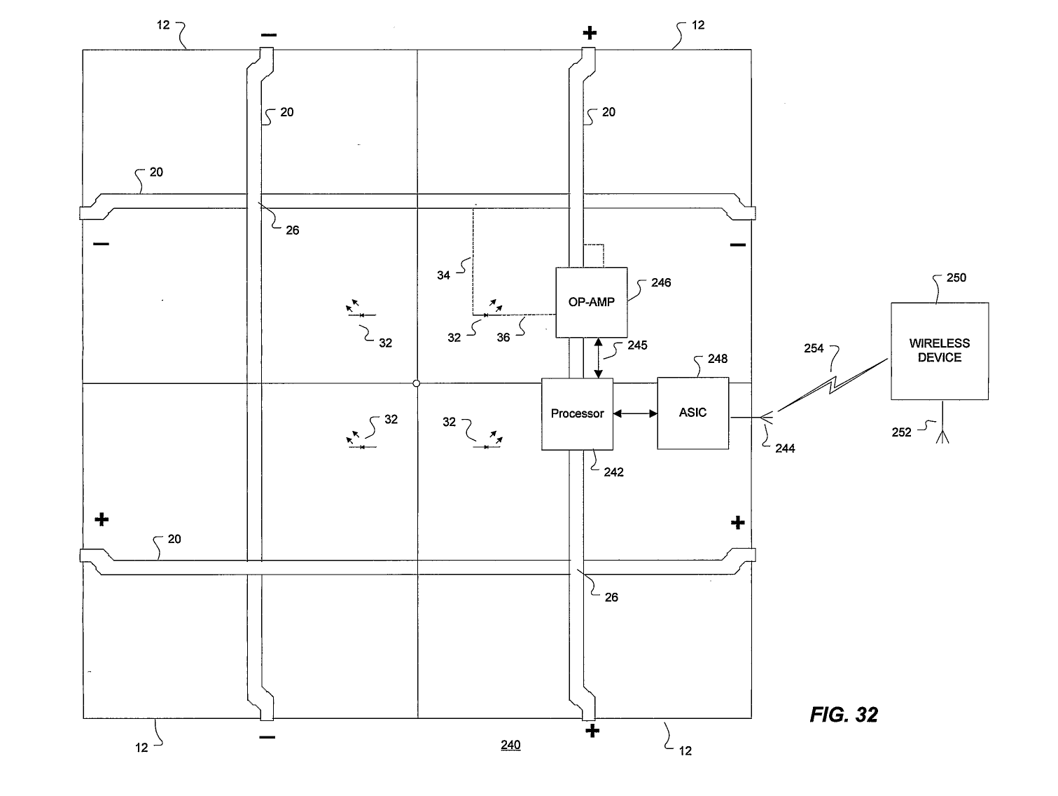

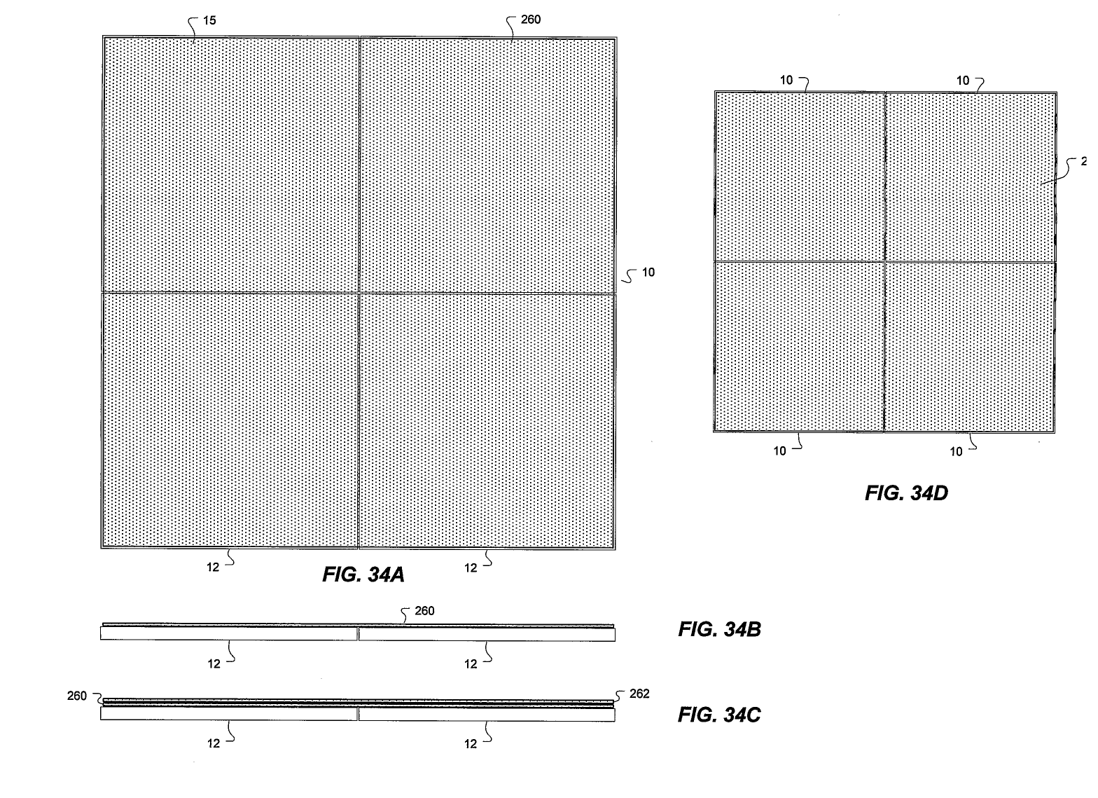

FIG. 8 depicts another exemplary architecture 54 similar to architecture 52. In architecture 54, translucent graphics 50 are applied to one or more non-interactive components (border tiles in one exemplary embodiment). The translucent graphics 50 may be comprised of a removable layer, such as layer 260 shown in FIGS. 34A and 34B. Accordingly, different graphics may be temporally applied to architecture 54. These graphics may be changed or become damaged due to user activity. In one embodiment the border components may produce illumination that amplifies or emphasizes the visibility of the applied graphics. The components 30 and 40 may produce a common wavelength illumination (such as the light wavelength corresponding to the color white) or different wavelength light and illumination levels such as in a component where the color and intensity of the component 30 or 40 illumination is controllable (FIG. 32). A user or the system controller 210 (FIG. 30) may direct or control the color and intensity of a border component as a function of the applied graphic(s) in an exemplary embodiment.

In FIG. 4, cables 18 and couplings 32 were employed to enable communication with multiple interactive components 10. FIG. 9 depicts an exemplary component 60 that communicates with one or more adjacent components via at least one optical transceiver 62, 64.

The component 60 includes, in part a first optical transceiver 62, a second optical transceiver 64, a multiplexer 72, a processor 76, and a communication controller 74. In this exemplary embodiment, the first and second optical transceivers 62, 64 are coupled to a multiplexer 72. The multiplexer 72 enables transmission of signals between one of two optical transceivers 62 and 64 (via line S1 and S2 respectively) and the communication controller 74 (via line D) based on the control line, C. The processor 76 sets the control line, C based on the system topology or direction from a system controller (such as 210 shown in FIG. 30).

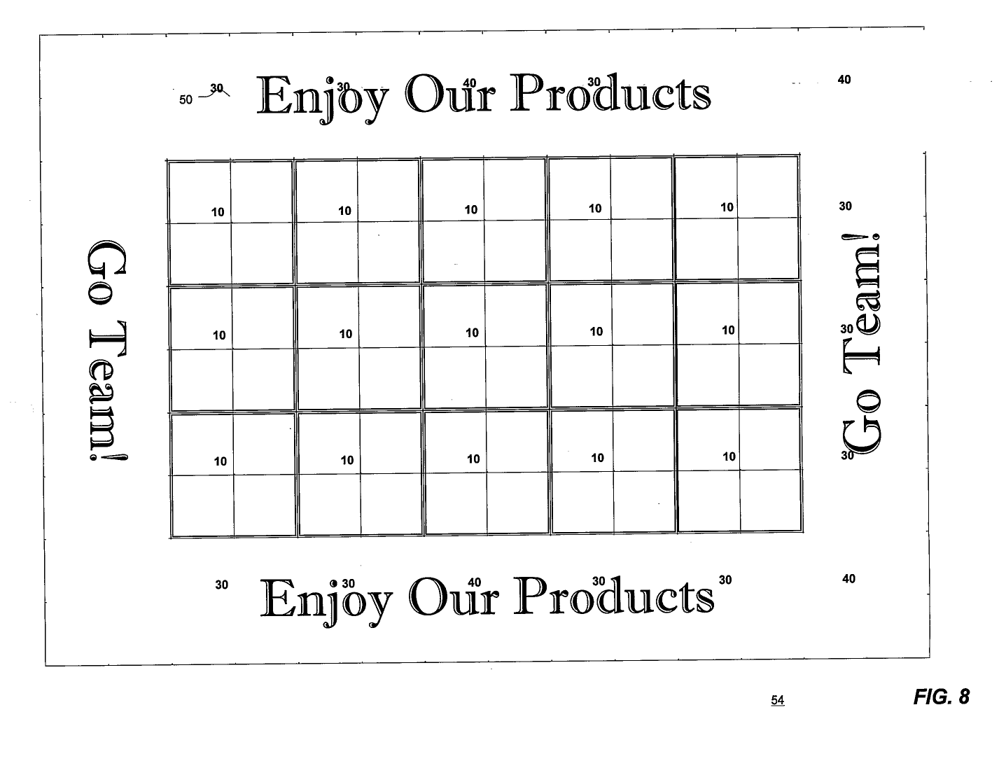

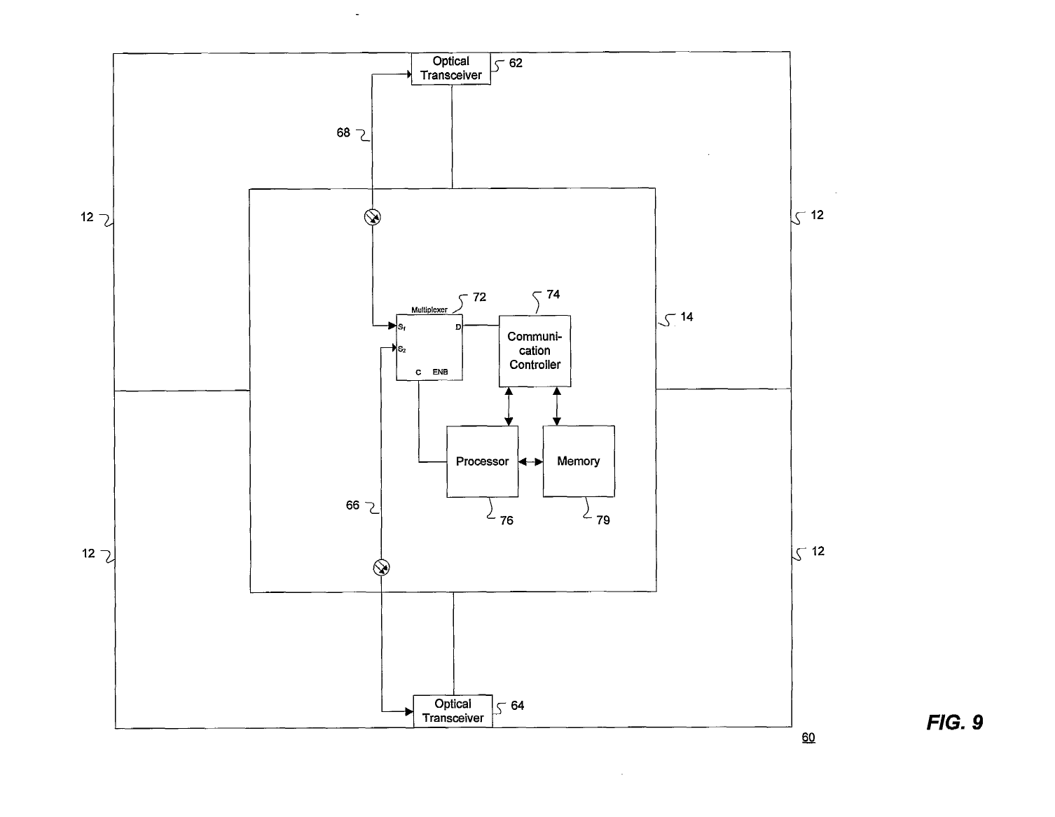

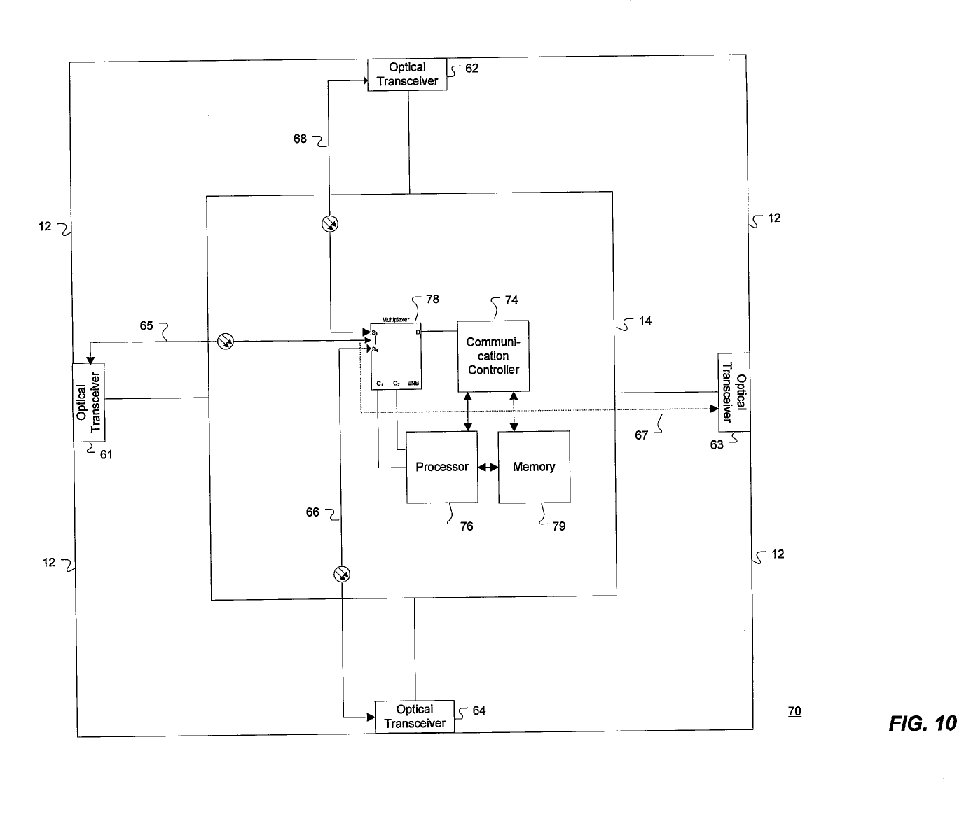

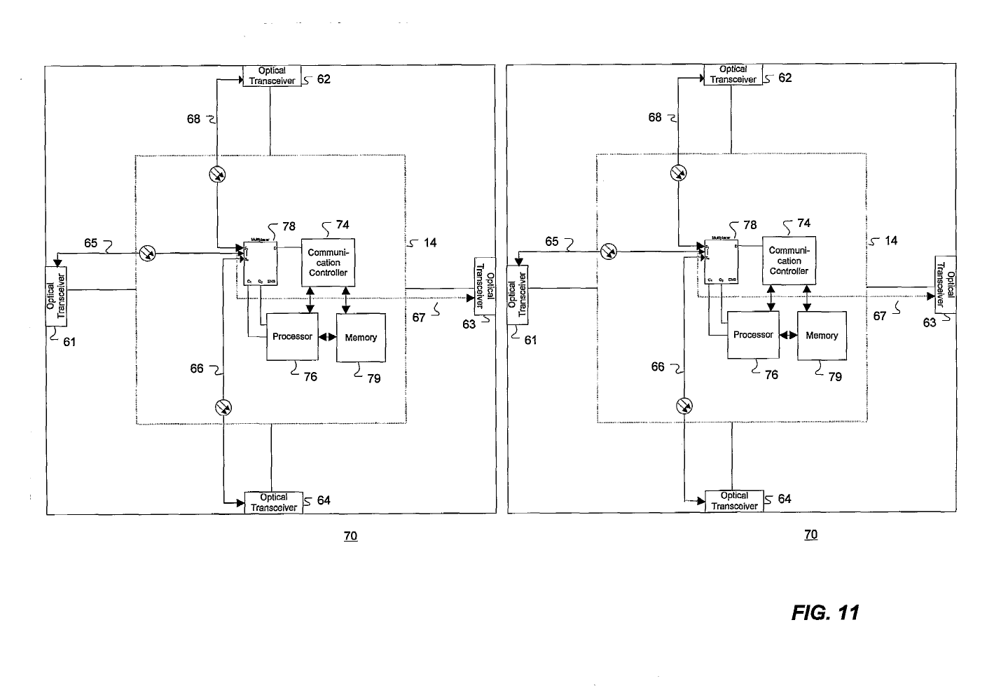

FIG. 10 depicts another exemplary component 70 that communicates with one or more adjacent components via at least one optical transceiver. The component 70 includes, in part a first, a second, a third, and a fourth optical transceiver 61, 62, 63, and 64, a 4 to 1 multiplexer 78, a processor 76, and a communication controller 74. In this exemplary embodiment, the first, second, third, and fourth optical transceivers are coupled to a multiplexer 78. The multiplexer 78 enables transmission of signals between one of four optical transceivers 61 to 64 (via line S1 to S4 respectively) and the communication controller 74 (via line D) based on the control lines, C1 and C2. The processor 76 may set the control lines, C1 and C2 based on the system topology or direction from a system controller (such as 210 shown in FIG. 30). In an exemplary embodiment, the component 70 may have an optical transceiver for each possible adjacent component. For example, a component having an octagonal shape (eight sides) may have up to eight adjacent components. In this embodiment, the component may have eight optical transceivers, a transceiver for each side of the component. Such a component as this or component 60 and 70 provides redundancy in case of transceiver or alignment errors. Such components do not require a direct connection or coupling. A set of the components' 60 or 70 optical transceivers may only need to be placed in close proximity depending on the alignment tolerances of the transceivers such as shown in FIG. 11. In this figure, the components 70 may communicate via the optical transceiver 63 (of the left component) and optical transceiver 61 (of the right component).

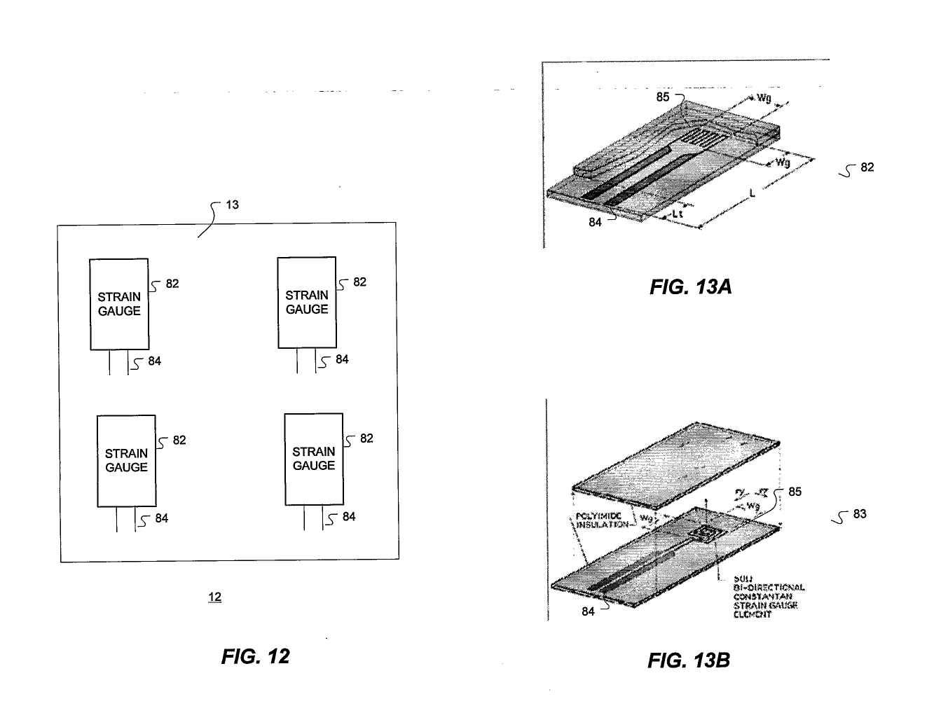

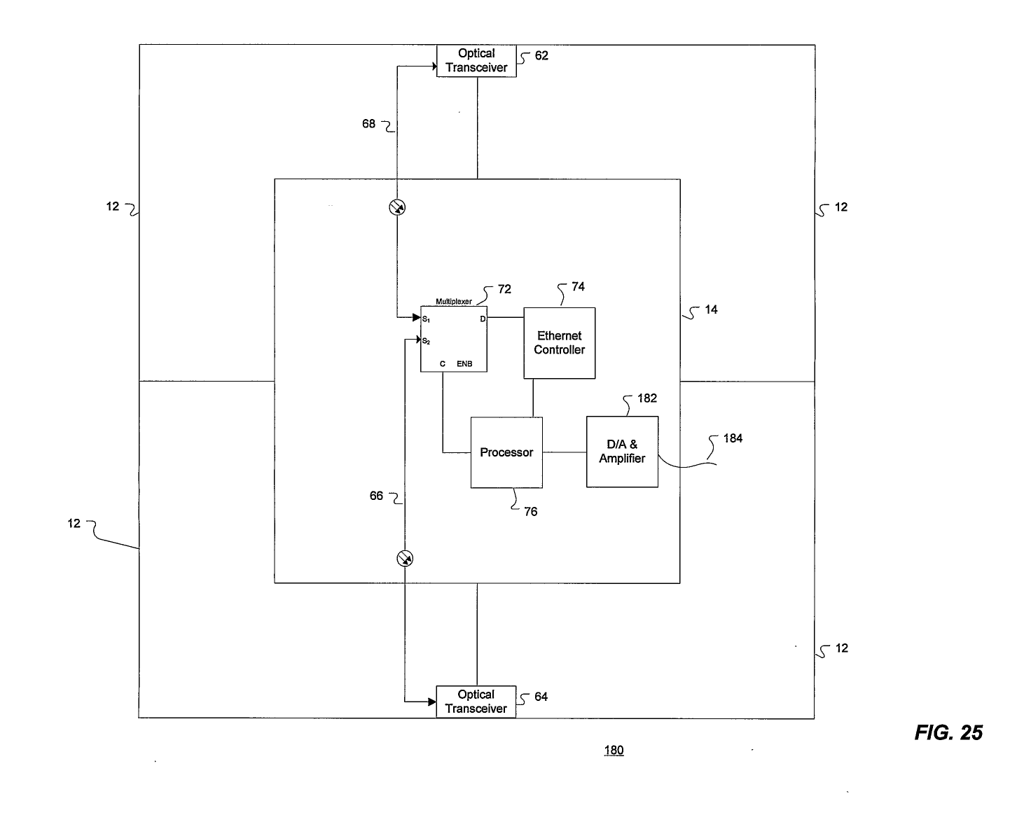

FIG. 12 depicts a diagram of another exemplary component sub-element 12 that includes one or more strain gauges 82. The component's sub-element 12 includes a plurality of strain gauges applied to an interior surface 13. When pressure is applied to the sub-element's 12 surface 15, the resistance of one or more of the strain gauges 82 may change proportionally depending on their location and geometry. A strain gauge's leads 84 may be coupled to the processor 76 via an analog to digital converter (“A/D”) 182 such as shown in FIG. 25. Accordingly, the processor 76 may monitor the resistance of a strain gauge 82 and thus the sub-element's 12 surface movement. The processor 76 may use this data to control a user detectable effect (the interaction between a user causing the movement of the sub-element. In an exemplary embodiment, the processor may control the illumination level or color for one or more lighting elements associated with the sub-element 12 based on the measured strain gauge resistance. The processor 76 may also transmit the movement data to a system controller (such as 210 in FIG. 30).

FIGS. 13A and 13B depict the geometry of a unilateral 82 and a bilateral 83 strain gauge, respectively. These strain gauges may be a thin extensoresistive (piezoresistive) or extensoelectric (piezoelectric) device. The unilateral strain gauge 82 enables the measurement of one lateral strain and the bidirectional strain gauge 83 enables the simultaneous measurement of the sum of two orthogonal lateral strains. Each strain gauge 82 and 83 includes a grid where the grid may be comprised of a thin Constantan (Cu:55%, Ni:45%) sensor that is photo-etched and glued upon a thin polymer backing film. In an exemplary embodiment the strain gauge may placed on the sub-element 12 via a silk screening process.

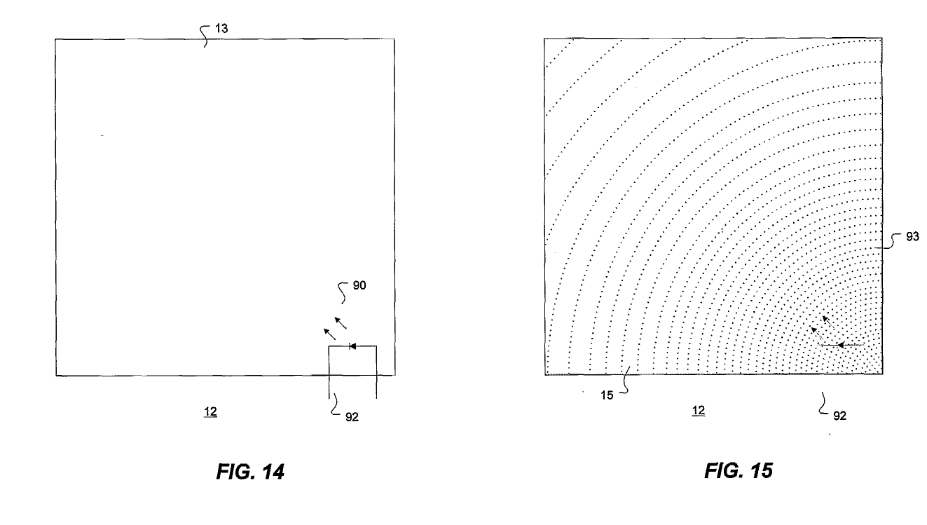

FIG. 14 is a diagram of an exemplary component sub-element 12 having one or more lighting elements 90 located in non-central region. The lighting element 90 may be located in this region to reduce the length of electrical connection lines 92 leading to the bus bar system or to an element of the PCB 14. The lighting element placement shown in FIG. 14 may create a bright illumination near the element that dims as a function of the radial distance from the lighting element 90. In one exemplary embodiment a grating pattern 93 is placed on an exterior surface 15 of the sub-element 12 as shown in FIG. 15. The grating pattern 93 may also be placed on the interior surface 13 of the sub-element 12 in another embodiment of the invention. The grating pattern 93 reduces the light intensity at or near the lighting element 90 by reducing the light energy that may radiate through the sub element 12 near the element 90. The pattern 93 permits greater light energy to radiate through the sub-element 12 as of the radial distance from the lighting element 90 increases (as shown in FIG. 15). Other patterns having similar properties may be applied to even the light intensity distribution on the surface of the sub-element 12.

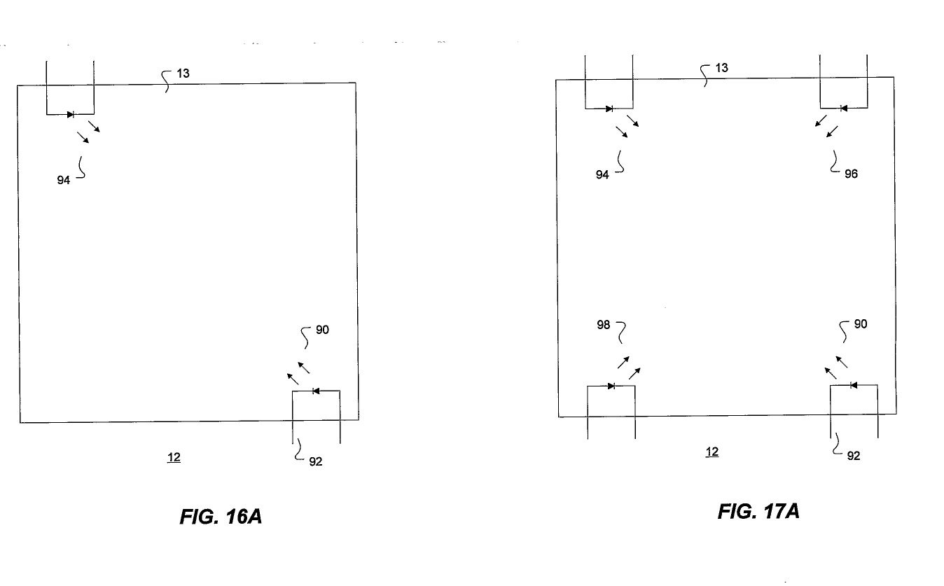

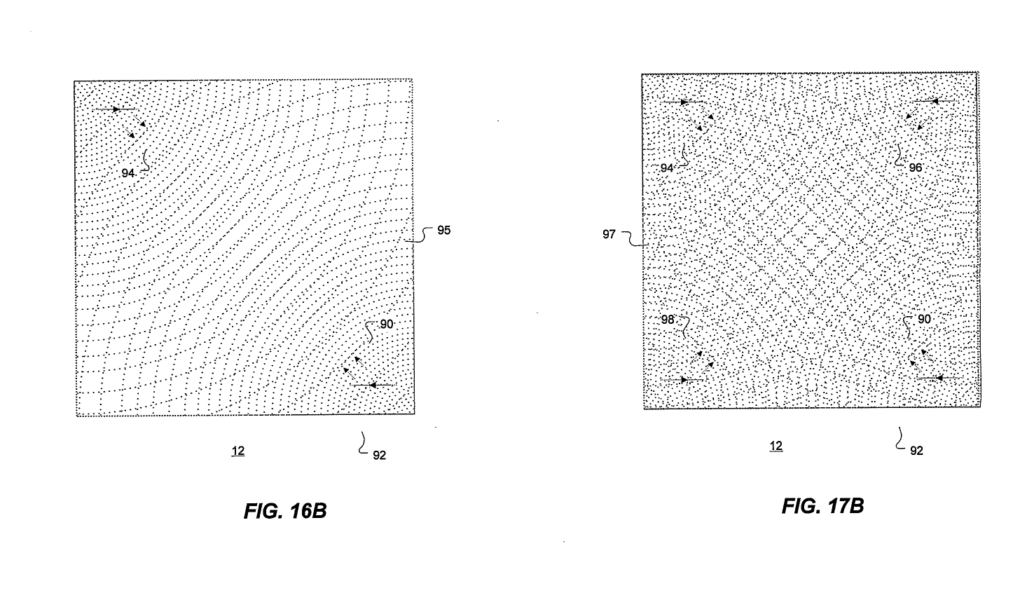

In an exemplary embodiment, the sub-element 12 may include additional lighting elements, such as two lighting elements (90 and 94) as shown in FIG. 16A and four lighting elements (90, 94, 96, and 98) as shown in FIG. 17A. It is noted that each lighting element may be comprised of multiple sub-lighting elements, e.g., in one exemplary embodiment each lighting element 90, 94, 96, and 98 is comprised of a red, a blue, and a green LED. In the embodiments shown in FIGS. 16A and 17A it still may be desirable to include a grating pattern to even light energy distribution across the sub-element's 12 exterior surface 15. Exemplary grating patterns 95, 97 for the two and the four lighting element configurations are shown in FIGS. 16B and 17B respectively where other grating patterns having similar properties may be applied to even the light intensity distribution in the sub-element's 12 exterior surface 15.

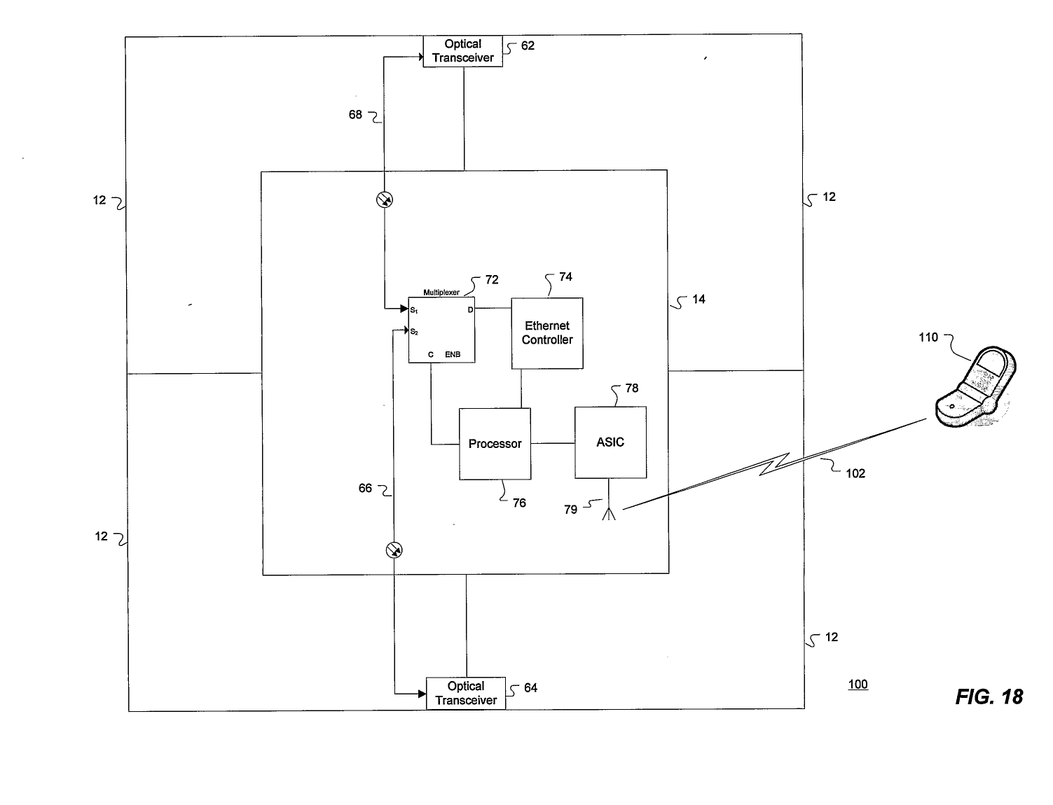

FIG. 18 depicts a diagram of an interactive component 100 that may wirelessly communicate with a nearby user's wireless device 110. In one embodiment an interactive component's sub-element 12 included one or more strain gauges to measure a user's interaction with the component 10. The component 100 is similar to component 10 but further includes an Application Specific Integrated Circuit (“ASIC”) 78 and an antenna 79. The ASIC is coupled to the processor 76 and the antenna 79. In an exemplary embodiment the ASIC 78 supports one or more wireless protocols so the processor 76 may communicate with a user's wireless device 110 via the ASIC 78 and antenna 79 over the wireless link 102. The user's wireless device may be a cellular phone, personal data assistant (“PDA”), pager, or other portable electronic device that supports one or more wireless protocols.

The wireless device 110 may include a specific program or macro to communicate specific data uniquely identifying the corresponding user. A user may register the wireless device with the system controller 210 (FIG. 30) prior to interaction with the component 100. Based on timing signals and other data transmitted between the wireless device 110 and ASIC 78, the processor 76 may be able to determine the wireless device's (and the users') relative location, velocity, and acceleration vector relative to the component 100. The wireless protocol may include a Wireless Fidelity (“WiFi”) protocol, a Bluetooth protocol, a cellular (such as Groupe Special Mobile (“GSM”), Code Division Multiple Access (“CDMA”), Cellular Digital Packet Data (“CDPD”), Advanced Mobile Phone Service (“AMPS”), and Time Division Multiple Access (“TDMA”) protocol, an Infrared Data Association (“IrDA”) protocol, or any other wireless protocol.

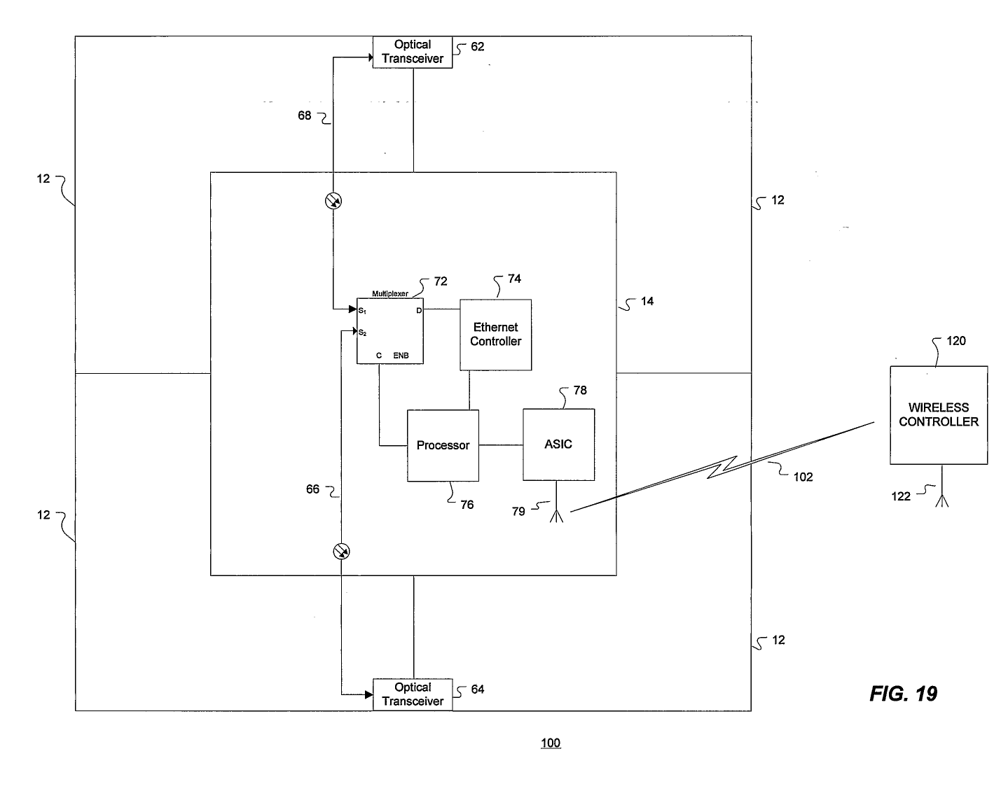

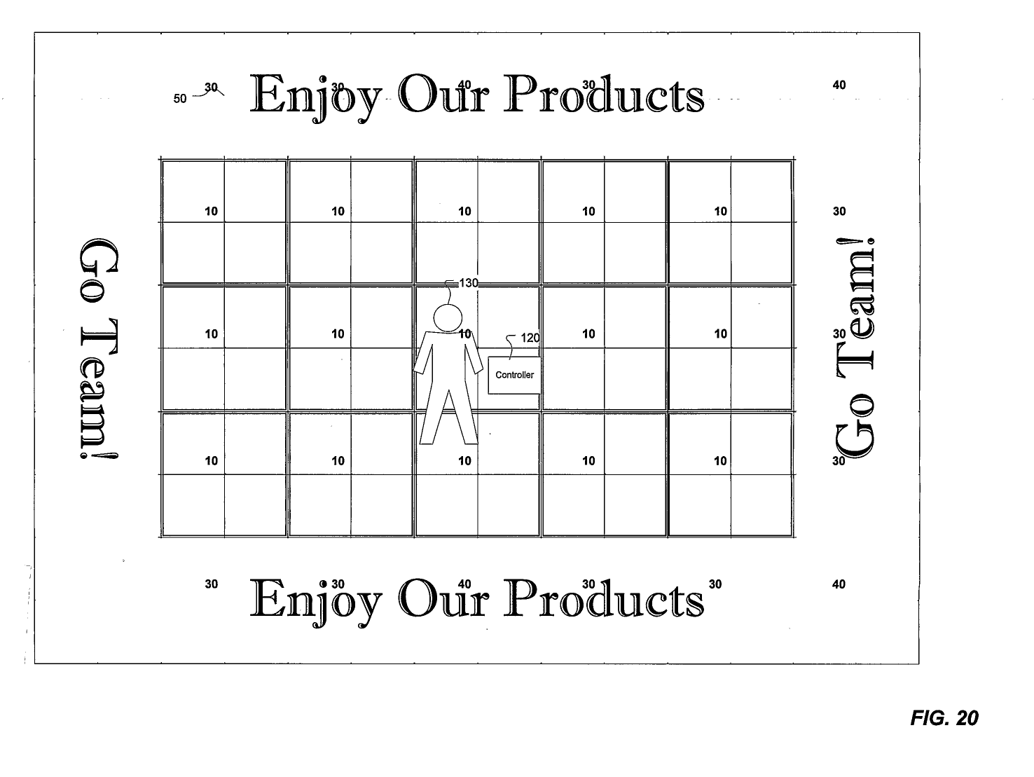

FIG. 19 depicts a diagram of the interactive component 100 where the component may also wirelessly communicate with a wireless controller 120 having an antenna 122. The wireless controller 120 may be a cellular phone, personal data assistant (“PDA”), pager, laptop, tablet personal computer (“PC”) or other portable electronic device that supports one or more wireless protocols device. The controller 120 may include one or more macros or programs that enable the wireless controller to send commands to and receive data from the component 100 via the wireless link 102. As shown in FIG. 20, a system operator 130 may use the wireless controller 120 to communicate with one or more interactive components 100 or 10. The system operator 130 may check or change the communication topology, adjust the lighting elements, or perform other system maintenance. In addition, the system operator 130 may modify one or more programs operating or being executed by a component's processor 76.

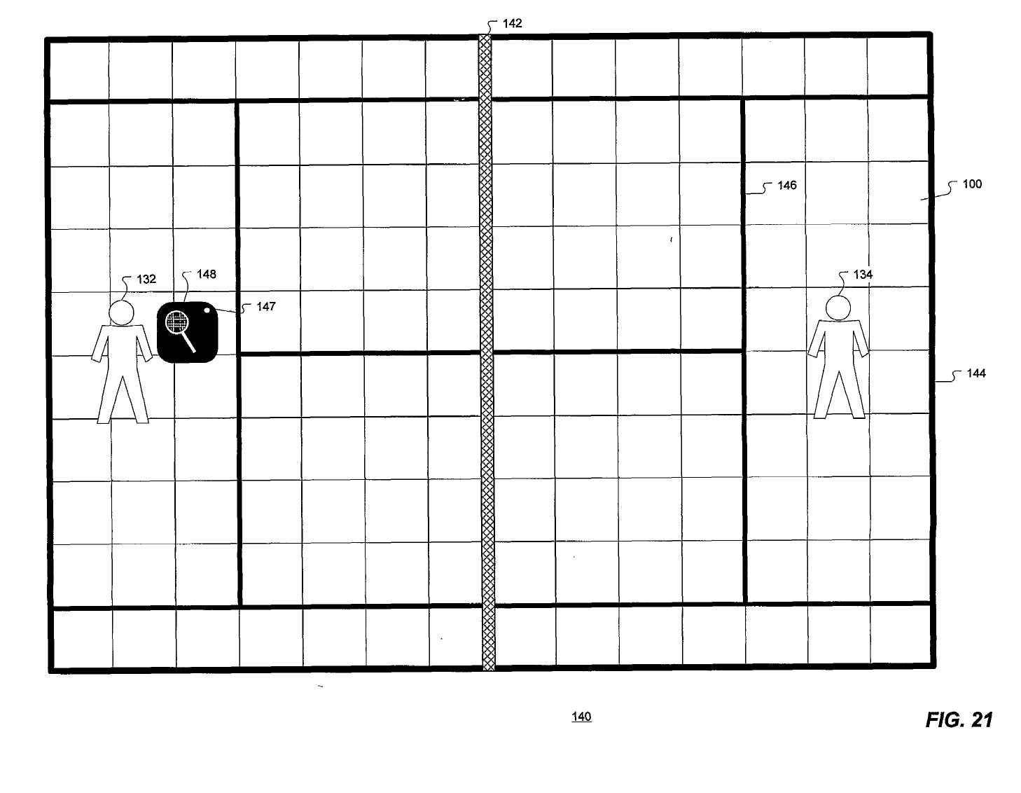

The components 10, 30, 40, and 100 may be employed to interact with users in many different environments. FIG. 21 depicts a diagram of one exemplary environment where the present invention may be employed, a sports environment, in particular as part of an interactive tennis court 140. The court 140 is comprised of a plurality of interconnected components 100. The components 100 may communicate via optical transceivers 62 and 64 (as shown in FIG. 10) and may be powered by a bus bar system. The tennis court includes boundaries such as the backcourt 144 and service line 146 and a net 142. One or more players 132, 134 may play tennis on the court 140 using a racket 148 and a tennis ball 147. During training, only one player may be using court 140, e.g. to practice serves or return balls from an automatic ball machine. In one exemplary embodiment the user's tennis shoes may include uniquely identified wireless devices that may communicate with the components 100 that comprise the court 140. Accordingly, a system controller may be able to map a user's location throughout practice or during a match. A line judge or umpire may able to use the user mapping to determine whether a user committed a foot fault during a serve. A coach may be able to use the mapping to train the player. Further, during training the court 140 may provide feedback to the user to aid their practice.

In another exemplary embodiment the tennis ball 147 may include a wireless device that communicates with the court 140. In this embodiment, the position of the ball may be mapped during practice and during a match. A line judge or umpire may able to use the ball mapping to determine whether a serve fault was committed or a passing shot was out. A coach may be able to use the ball mapping in conjunction with the player mapping (or alone) to train the player. Further, during training the court 140 may provide feedback to the user to aid their practice based on the ball mapping and/or player mapping.

In another exemplary embodiment the tennis ball may include more reflective or less reflective material. In this embodiment, the ASIC may function as a radar system where the system transmits electromagnetic towards and receives reflected electromagnetic energy from the ball. Depending on the transmitted signal modulation (Doppler, single side band, double side band, or other known modulation), the ASIC may be able to determine flight characteristics of the tennis ball including location, velocity vector, and acceleration vector. Further, each component 100 of the court 140 may have a unique modulation (time, frequency, or combination) so its radar signal is orthogonal to other component's radar signals. In addition, the exemplary radar signal is modulated so a target object can be detected even when its velocity vector is zero (not moving).

Further, in an exemplary embodiment a player and or their shoes may also have a material that is more or less reflective of electromagnetic energy so the player may be mapped by a Radar system based ASIC. In an exemplary embodiment, the court may show a trace of the ball in flight (projected along a normal vector to the court's surface). In addition, the court could be employed to display scoring, advertising or other information to the player, line judge, umpire, coach, or viewers of the match. Although not shown a plurality of border components 30 and power supplied border components 40 may be employed around the tennis court 140. In addition, some components 100 may include power supplies in an exemplary embodiment.

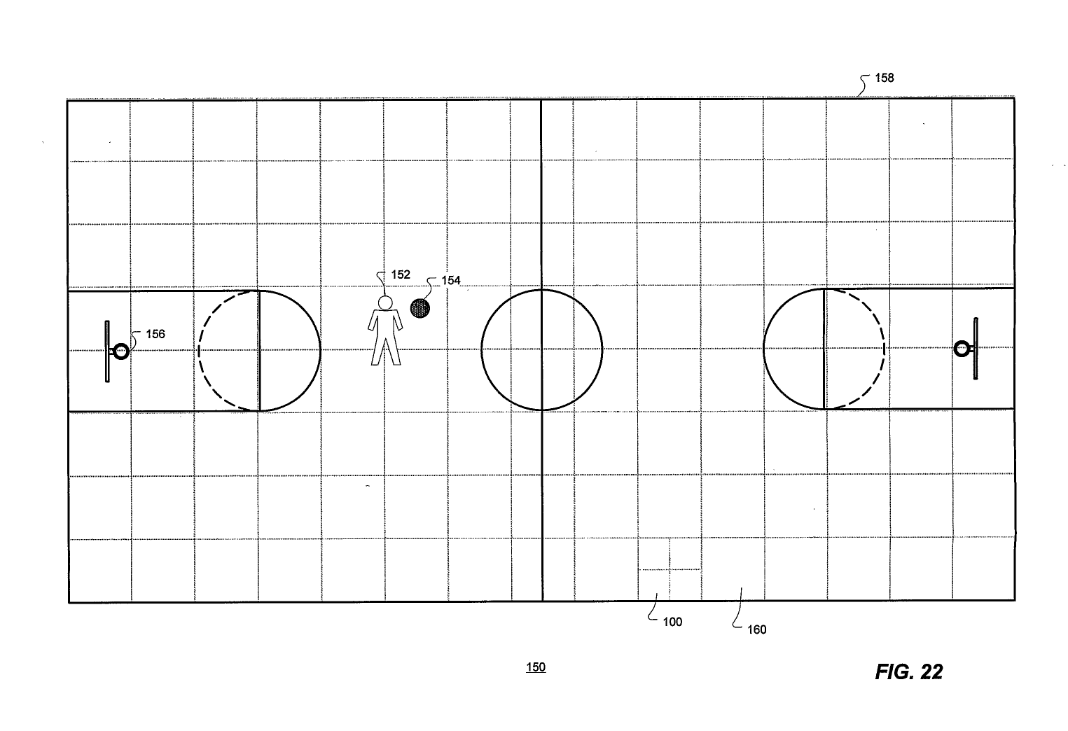

In a further exemplary embodiment a player's racket 148 may include a wireless device (transmitter) or have more or less electromagnetically reflective material to enable one or more components 100 of the court 140 to map its location during practice or during a match. As before, the racket mapping (along with or without the ball mapping and player mapping) may be used to enhance training or match regulation. The system 140 could be modified for similar use in other sporting environments. FIG. 22 depicts a diagram of another exemplary implementation of the present invention in a sports environment, in particular as a basketball court 150 comprised of a plurality of components 100 (where segment 160 represents a plurality of components 100). The basketball court also has boundaries 158 and has one or more rims 156 (half court implementation may have a single rim). Similar to the tennis court implementation 140, the players 152 and/or the basketball 154 may have a wireless device or transmitter on their person or shoes, or in the basketball 154. In addition, the players 152 may have a more or less electromagnetically reflective material on their person or shoes, or in or on the basketball 154 so the component 100 may be able to map their position (the player or basketball 154) during practice or a match. Further, the player's wireless transmitter may uniquely identify the player. Further the more or less electromagnetically reflective material may be controlled to uniquely identify each player or ball.

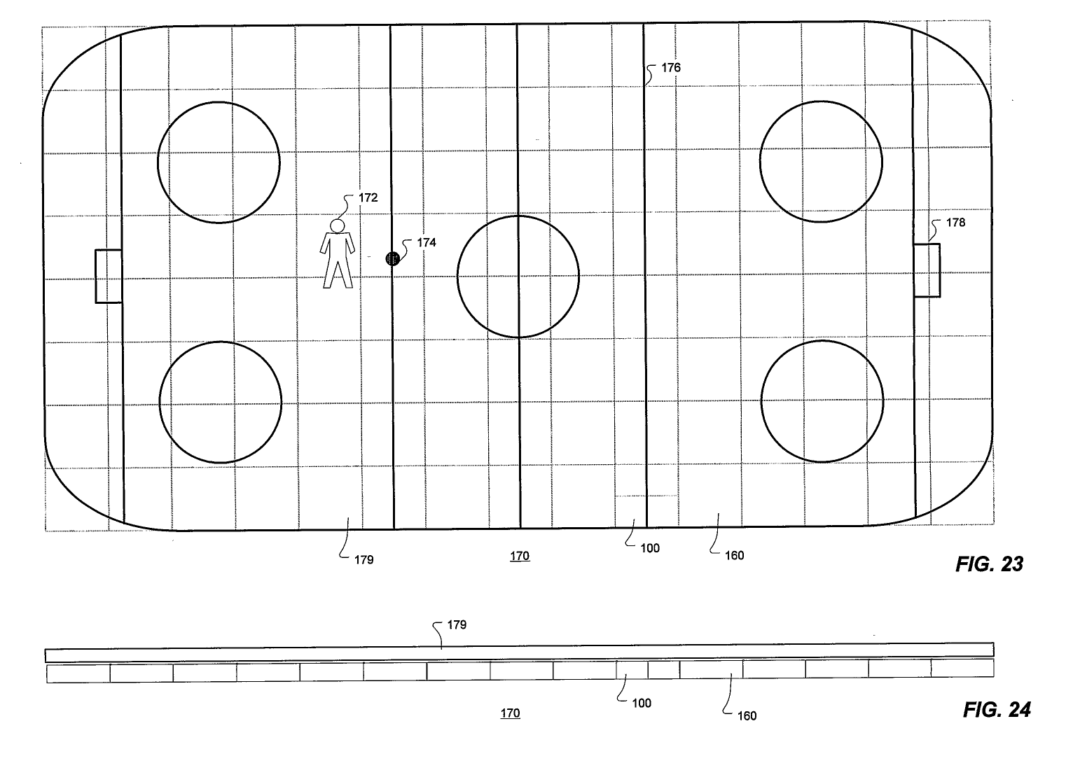

FIGS. 23 (top view) and 24 (side view) depict diagrams of another exemplary implementation of the present invention in a sports environment, in particular a hockey system 170 underlying a hockey rink ice 179 comprised of components 100 (where segment 160 represents a plurality of components 100). The hockey rink 179 has boundaries 176 and one or more goals 178 (half rink implementation may have a single goal). Similar to the tennis court implementation 140, players 172 and/or a puck 174 may have a wireless device or transmitter on their person or shoes, or in the puck 174. In addition, the players 172 may have a more or less electromagnetically reflective material on their person or skates (the blade itself may be sufficient), or in or on the puck 154 so components 100 may be able to map their position (the player 172 or puck 174) during practice or a match. Further, the player's wireless transmitter may uniquely identify the player 172. Further the more or less electromagnetically reflective material may be controlled to uniquely identify each player 172. The system 170 may be employed to enhance other rink activities such as figure skating or ice shows.

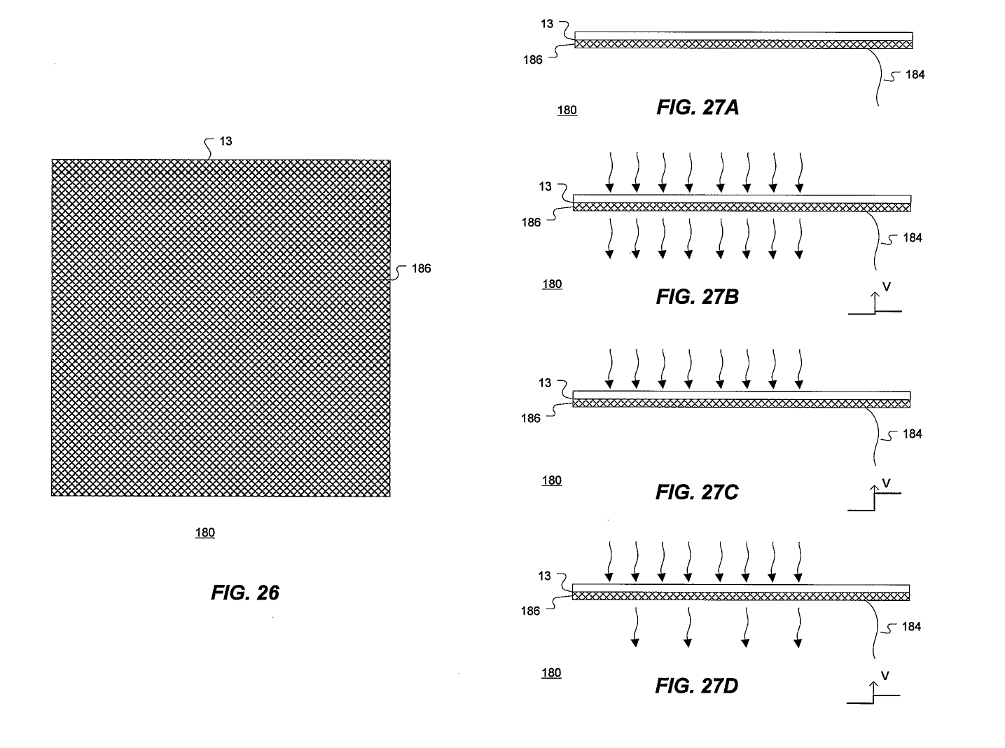

When a lighting element of a component's sub-element′ 12 is not producing light it may be desirable that the sub-element 12 appear dark or black. Light energy from surrounding components and other light sources may cause a non-self-illuminated sub-element 12 to appear illuminated. FIGS. 25 to 27D depict diagrams of and show operation of an exemplary interactive component 180 having a controllable surface translucence 186 in accordance with the present invention. Interactive component 180 is similar to component 60 shown in FIG. 9. Component 180 further includes a D/A and amplifier 182 coupled to the processor 76 and a translucence controllable material 186 via an electrical connector 184. In an exemplary embodiment the material is placed on the interior surface 13 of the component's sub-elements 12. In addition, the component 180 may include a separate D/A and amplifier 182 for each sub-element 12. The component 180 controls the translucence of the material 186 by varying an electrical signal supplied to the material by the processor 176 via the D/A and amplifier 182 an conductor 184.

In one embodiment, when a sub-element's 12 lighting element is active, the processor 176 may control the material 186 to become translucent as shown in FIG. 27B. In this embodiment, when a sub-element's 12 lighting element is not active, the processor 176 may control the material 186 to become opaque as shown in FIG. 27C. Accordingly, the sub-element 12 may appear black or dark when its corresponding lighting element(s) are not active (being actively driven). There may also be embodiment where the material is driven to permit some passage of light energy as shown FIG. 27D. In one embodiment the material 186 may be comprised of an electrically controllable liquid crystal polarizer or other material having electrically controlled light filtering characteristics.

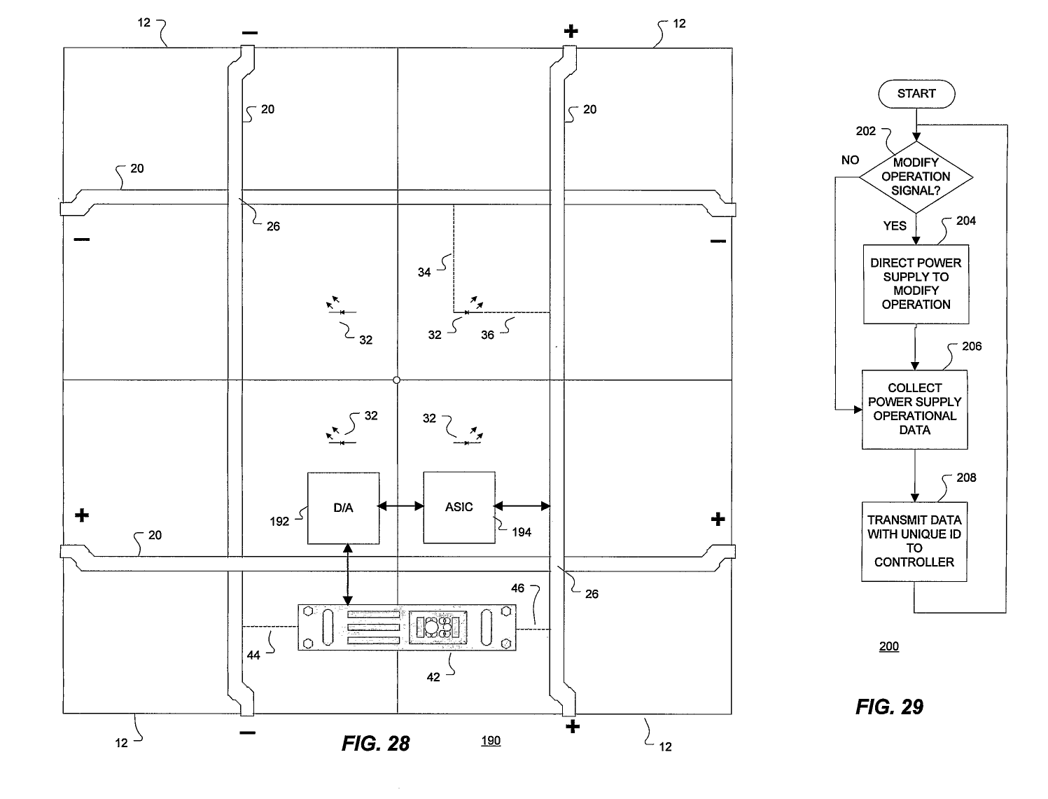

In an exemplary embodiment the system 210 (of FIG. 30) may monitor and control the operation of one or more controllable power supplied equipped components 190 (shown in FIG. 28). The exemplary controllable power supplied equipped component 190 with bus bars is similar to component 40 of FIG. 6. Component 190 further includes a D/A 192 and ASIC 194. The D/A converter is coupled to the power supply 42 and ASIC 194 and the ASIC 194 is further coupled to the bus bar system 20. In an exemplary embodiment the power supply 42 is a controllable power supply that provides operational data and whose operation can be modified by one or more control signals. The D/A 192 formats analog operational data generated by the power supply and converts digital control signals from the ASIC 194 to analog control signals for the power supply 42. In another exemplary embodiment the power supply 42 may support digital signals. In this embodiment the power supply 42 may be coupled directly to the ASIC 194.

FIG. 29 depicts a flow diagram of an exemplary process 200 that may be executed by the exemplary controllable power supplied equipped component 190. The process 202 directs the power supply to modify its current operation parameters when it receives a modify operation signal (steps 204 and 202). The parameters to be modified may be the wattage output, voltage level, and current level. The process 200 may also direct the power supply 42 to collect operational data or parameters such as the present wattage output, voltage level, current level, and temperature (step 206). The ASIC 194 may transmit this data (operational parameters) along a unique ID associated with the component 190 to the system 210 via the bus bar system 20. The ASIC may modulate the data using any wired data protocol.

FIG. 30 depicts a block diagram of an exemplary system controller 210 that may communicate with the component 190. The system controller 210 includes a central processing unit (“CPU”) 212, storage medium 214, Random Access Memory (“RAM) 216, Read Only Memory (“ROM”) 218, D/A 222, Modem/transceiver 224, antenna 226, and a user interface 228. The CPU 212 may execute program instructions stored in the RAM 216, ROM 218, and storage medium 214 that enable the CPU to communicate with one or more components using a wired or wireless protocol. Signals may be communicated using a wired protocol via the D/A 222 where the D/A may be coupled to the bus bar system or the serial component link (via cables 18). Signals may be communicated wirelessly via the Modem/Transceiver 224 and antenna 224. The storage medium 214 may be any electronic storage device including magnetic or optical disk drive. The user interface 228 may be any device that enables a user to communicate with the CPU 212 including a keyboard, mouse, voice activated system, touch screen, and hand writing detection/conversion system. The user interface 228 may also include a user readable device such as a monitor (cathode ray tube (“CRT”), Liquid Crystal Display (“LCD”), or other), printer, or other device that may communicate with a user.

A user may employ the interface 228 to control the operation of components 10, 30, 40, 60, 100, 140, 160, 170, 190 coupled to the system controller 210. The system controller 210 may execute one or more programs that automatically monitor and control the operation of one or more components. For example, in one exemplary embodiment the system controller 210 performs the process 230 shown in flow diagram format in FIG. 30. The process 230 may be employed to control the operation of one or more power supplied equipped components 190. The process 230 may first assign a unique identifier (“ID”) to a power supplied equipped component (step 232). In an exemplary embodiment the process 230 assigns a unique ID to each power supplied equipped component in an interactive architecture controlled by the controller 210. When the process receives an operations data signal (at step 234), the process may determine whether the operational data meets a preset range of acceptable values, i.e., within specifications (step 236).

When the operational data indicates that the power supplied equipped component 190 is not operating within a desired range (or when no data is received within a predetermined time interval), the process may prepare and send a message to the power supplied equipped component 190 to modify its operation (steps 238 and 242). In an exemplary embodiment, the process 230 may also direct other power supplied equipped components within the system architecture (such as system 52 shown in FIG. 7) to modify their operation, it particular components 190 near the malfunctioning power supplied equipped component 190 (steps 238, 242). When these attempts to modify the operation of the malfunctioning component 190 and other components 190 are not successful, the process 230 may shutdown the bus bar system (step 246). In an exemplary embodiment, the process 230 may shutdown the bus bar system by directing each power supply within each power supplied equipped component 190 to cease operation.

In another embodiment of the present invention it may be desirable to control the operation of non-interactive components (such as component 30 of FIG. 5) via the system controller 210 or a wireless device. FIG. 32 depicts a diagram of exemplary architecture that includes a wirelessly controllable non-interactive component 240 and a wireless device 250 with antenna 252. The component 240 is similar to component 30 but further includes an operational amplifier (“OP-AMP”) 246, a processor 242, an ASIC 248, and an antenna 244. The ASIC 248 is coupled to the processor 242 and the antenna 244. In an exemplary embodiment the ASIC 248 supports one or more wireless protocols so the processor 242 may communicate with the wireless device 250 via the ASIC 248 and antenna 244 over the wireless link 254. The wireless device 250 may be a cellular phone, personal data assistant (“PDA”), pager, or other portable electronic device that supports one or more wireless protocols such as a Wireless Fidelity (“WiFi”) protocol, a Bluetooth protocol, a cellular (such as Groupe Special Mobile (“GSM”), Code Division Multiple Access (“CDMA”), Cellular Digital Packet Data (“CDPD”), Advanced Mobile Phone Service (“AMPS”), and Time Division Multiple Access (“TDMA”) protocol, an Infrared Data Association (“IrDA”) protocol, or any other wireless protocol.

The wireless device 110 may include a specific program or macro to communicate operational commands to the processor 242. These commands may change the user detectable signal generated by the component 240. In the exemplary embodiment the component 240 includes a plurality of light emitting elements 32 that are coupled to the bus bar system 20 via the OP-AMP 246. The processor may direct the OP-AMP to change the intensity of one or more of the light emitting elements 32 based on commands received from the wireless device 250. In an exemplary embodiment, the system controller 210 may act as the wireless device 250 and transmit operational commands to the processor 242 via its modem/transceiver 224 (shown in FIG. 30). In such an embodiment each wirelessly controllable non-interactive component 240 may have a unique ID so the controller may address each individually. The system controller 210 or wireless device 250 may also send a operation command to modify the operation of all such components 240 in a system.

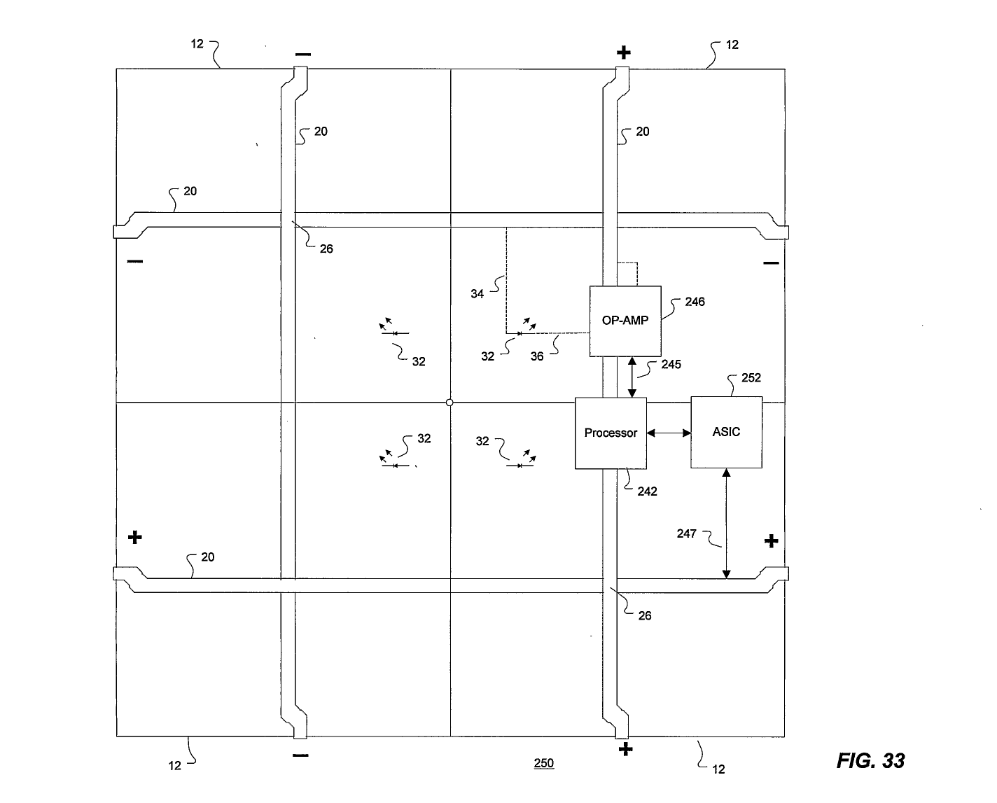

In another exemplary embodiment shown in FIG. 33, the processor 242 may receive operational commands from the bus bar system 20 via ASIC 252 and line 247. The ASIC 252 may support one or more analog or digital data communication protocols and may modulate and demodulate data signals on the bus bar system 20. The system controller 210 may transmit operational commands to the processor 242 via its D/A 222 (shown in FIG. 30) and the bus bar system. In such an embodiment each bus bar system based controllable non-interactive component 250 may have a unique ID so the controller may address each individually. The system controller 210 may also send an operation command to modify the operation of all such components 240 in a system.

In a further exemplary embodiment it is desirable to protect the surface of one or more components of an interactive system or to provide graphics or a grating pattern on the surface of one or more components. FIG. 34A depicts a diagram of a component with a protective layer 260 on its surface in accordance with an embodiment of the present invention. In this embodiment the protective layer is a removable translucent film. The film may prevent material (such as dirt or water) from passing into the component's 10 surface 15. FIG. 3B depicts a side view of the component 10 with the translucent film covering 260. As shown in this figure the film may prevent material from penetrating between the component's sub-elements 12. In an exemplary embodiment of the invention the protective covering 260 includes a plurality of removable translucent film layers 262 as shown in FIG. 34C in cross section. Further in another exemplary embodiment the protective layer 264 may be large enough to span over a plurality of components such as shown in FIG. 34D. In this embodiment, the protective layer 264 may prevent material from penetrating between components 10. As noted the layers may include one or more graphics or grating patterns as shown above.

While this invention has been described in terms of a best mode for achieving the objectives of the invention, it will be appreciated by those skilled in the wireless communications art that variations may be accomplished in view of these teachings without deviating from the spirit or scope of the present invention. For example, the present invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc., or by transmitting the code on a network for remote execution.

What is claimed is:

1. An interactive system, the system comprising:
a plurality of controllable interactive components, each controllable, interactive component including:
means for detecting some physical characteristic of a user proximal to the controllable interactive component; and
means for transmitting the detected physical characteristic in a data signal to an interactive component system controller;
a plurality of bus bars, the bus bars forming a network where each of the plurality of controllable interactive components is electrically coupled to the bus bar network at least once;
a power supply coupled to the bus bar network to provide power to the plurality of controllable interactive components.

2. The interactive system of claim 1, wherein each controllable interactive component further comprises means for generating a human detectable effect as a function of the detected physical characteristic.

3. The interactive system of claim 1, wherein each controllable interactive component further comprises:
means for receiving a generate effect data signal from the interactive component system controller where the generate effect data signal is based on the detected physical characteristic; and
means for generating a human detectable effect based on the generate effect data signal.

4. The interactive system of claim 3, wherein the means for generating a human detectable effect based on the generate effect data signal includes a photon generation element.

5. The interactive system of claim 1, further comprising a non-interactive component electrically coupled to the bus bar network, the non-interactive component including means for generating a human detectable effect.

6. The interactive system of claim 5, wherein the means for generating a human detectable effect includes a photon generation element.

7. The interactive system of claim 1, wherein each controllable interactive component further comprises:
means for detecting some physical characteristic of a moving, non-human object proximal to the controllable interactive component; and
means for transmitting the detected moving object physical characteristic in a data signal to the interactive component system controller.

8. The interactive system of claim 7, wherein each controllable interactive component further comprises means for generating a human detectable effect indicating a characteristic of the moving, non-human object proximal to the controllable interactive component.

9. The interactive system of claim 8, wherein the means for generating a human detectable effect indicating a characteristic of the moving, non-human object proximal to the controllable interactive component includes a photon generation element.

10. The interactive system of claim 1, wherein the means for transmitting the detected physical characteristic is electrically coupled to the bus bar network and the data signal is communicated to the interactive component system controller via the bus bar network.

11. The interactive system of claim 3, wherein the means for transmitting the detected physical characteristic is electrically coupled to the bus bar network and the data signal is communicated to the interactive component system controller via the bus bar network and wherein the means for receiving a generate effect data signal is electrically coupled to the bus bar network and the generate effect data signal is communicated from the interactive component system controller via the bus bar network.

12. The interactive system of claim 1, wherein the means for transmitting the detected physical characteristic includes an optical transmitter.

13. The interactive system of claim 3, wherein the means for transmitting the detected physical characteristic includes an optical transmitter and wherein the means for receiving a generate effect data signal includes an optical receiver.

14. The interactive system of claim 13, wherein the plurality of controllable interactive components communicate data signals between the interactive component system controller and each controllable interactive component via the optical transmitter and receiver serially.

15. An interactive system, the system comprising:
a plurality of controllable interactive components, each controllable, interactive component including:
means for detecting some physical characteristic of a user proximal to the controllable interactive component; and
an optical transmitter, the transmitter transmitting the detected physical characteristic in a data signal to an interactive component system controller.

16. The interactive system of claim 15, wherein each controllable interactive component further comprises means for generating a human detectable effect as a function of the detected physical characteristic.

17. The interactive system of claim 15, wherein each controllable interactive component further comprises:
a plurality of bus bars, the bus bars forming a network where each of the plurality of controllable interactive components is electrically coupled to the bus bar network at least once; and
a power supply coupled to the bus bar network to provide power to the plurality of controllable interactive components.

18. The interactive system of claim 15, wherein each controllable interactive component further comprises:
an optical receiver, the receiver receiving a generate effect data signal from the interactive component system controller where the generate effect data signal is based on the detected physical characteristic; and
means for generating a human detectable effect based on the generate effect data signal.

19. The interactive system of claim 18, wherein the means for generating a human detectable effect based on the generate effect data signal includes a photon generation element.

20. The interactive system of claim 17, further comprising a non-interactive component electrically coupled to the bus bar network, the non-interactive component including means for generating a human detectable effect.

21. The interactive system of claim 20, wherein each controllable interactive component further comprises:
means for detecting some physical characteristic of a moving, non-human object proximal to the controllable interactive component; and
means for transmitting the detected moving object physical characteristic in a data signal to the interactive component system controller.

22. The interactive system of claim 21, wherein each controllable interactive component further comprises means for generating a human detectable effect indicating a characteristic of the moving, non-human object proximal to the controllable interactive component.

23. The interactive system of claim 22, wherein the means for generating a human detectable effect indicating a characteristic of the moving, non-human object proximal to the controllable interactive component includes a photon generation element.

24. The interactive system of claim 15, wherein the plurality of controllable interactive components communicate data signals between the interactive component system controller and each controllable interactive component via the optical transmitter and receiver serially.
